(19) United States
(12) Patent Application Publication
(10) Pub. No.: US 2026/0189939 A1
(43) Pub. Date: Jul. 2, 2026

(54) COMMUNICATION SYSTEM AND RELATED PRODUCTS

(71) Applicant: Huawei Technologies Co., Ltd., Shenzhen (CN)

(72) Inventors: Hang Zhang, Ottawa (CA); Xu Li, Nepean (CA)

(21) Appl. No.: 19/547,188

(22) Filed: Feb. 23, 2026

Related U.S. Application Data
(63) Continuation of application No. PCT/CN2024/075632, filed on Feb. 2, 2024.
(60) Provisional application No. 63/579,815, filed on Aug. 31, 2023.

(51) Int. Cl. H04W 24/02

(52) U.S. Cl. CPC H04W 24/02

(57) ABSTRACT

The present disclosure relates to a communication system and related products. An example system includes: a first network element, at least one second network element, and at least one third network element. The first network element is communicatively connected to the at least one second network element and the at least one third network element, and configured to control operations of the at least one second network element and the at least one third network element. A second network element of the at least one second network element is communicatively connected to a fourth network element and configured to interact with the fourth network element on a control and management plane. A third network element of the at least one third network element is communicatively connected to a fifth network element and configured to interact with the fifth network element on a data plane.

### CROSS-REFERENCE TO RELATED APPLICATIONS

This application is a continuation of International Patent Application No. PCT/CN 2024/075632, filed on Feb. 2, 2024, which claims the benefits of U.S. Provisional Application No. 63/579,815, filed on Aug. 31, 2023, the disclosures of which are hereby incorporated by reference in their entireties.

### TECHNICAL FIELD

The present disclosure relates to the field of communication technologies, and in particular, to a communication system and related products.

### BACKGROUND

5G (5 th generation) system CP (control plane) SBI (service-based interface) uses SCP (Service Communication Proxy) and NRF (network Repository Function), etc. to support 5G CP plane indirect communication but not support strong trustworthiness. The control plane is generally used for managing state information, routing table and access control list, etc. of a network device, and communicates with other devices to realize functions such as routing. The data plane is generally used for processing and transmitting network traffic, i.e., forwarding a received data packet according to a preset rule, and ensuring that the data packet reaches a target device correctly.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a communication system, where the system includes: a first network element, at least one second network element and at least one third network element;
the first network element is communicatively connected to the at least one second network element and the at least one third network element, and configured to control operations of the at least one second network element and the at least one third network element;
a second network element of the at least one second network element is communicatively connected to a fourth network element and configured to interact with the fourth network element on a control and management plane; and
a third network element of the at least one third network element is communicatively connected to a fifth network element and configured to interact with the fifth network element on a data plane.

By managing at least one C/M-TW-GW (second network element) and at least one Data-TW-GW (third network element) by a C/M function (first network element) in the communication system, the following capability/services can be realized: controlling and managing a BAS domain/infrastructure domain/administration domain; enabling interactions among 6G XaaS services provided by same or different partners and enabling interactions between 6G XaaS services and verticals and XaaS services deployed in 3rd party infrastructures/clouds; and providing a capability of anonymous interactions of XaaS services by implementing C/M-TW-GWs and Data-TW-GWs for better trustworthy management.

In a possible implementation of the first aspect, where the first network element is configured to:
obtain a first profile of the fourth network element; and
configure the second network element based on the first profile;
where the first profile includes at least one of a reachable address of the fourth network element used for establishing a connection between the fourth network element and the second network element or an authorization profile of the fourth network element, and the authorization profile of the fourth network element is used for determining a consumer to which the fourth network element is capable of providing the first basic service.

By virtue of the reachable address of the fourth network element, a logical and secured connection between the fourth network element and the third first network element can be established under the control of the first network element, and by virtue of the authorization profile, a consumer to which the fourth network element is capable of providing a first basic service (e.g., X as a service, XaaS for short) can be determined by the first network element and the third first network element can be configured with information in the first profile from the fourth network element, thus realizing the configuration of the second network element.

In a possible implementation of the first aspect, where the first network element is configured to receive the first profile from the fourth network element.

In a possible implementation of the first aspect, where the second network element is configured to receive the first profile from a sixth network element connected to the second network element and forward the first profile to the first network element; and
the first network element is configured to receive the first profile from the second network element.

In a possible implementation of the first aspect, where the first network element is configured to receive the first profile from a first basic service to which the fourth network element belongs.

Based on the above, the first network element can receive the first profile of the fourth network element in various ways, so the reception of the first profile can be set flexibly according to actual requirements.

In a possible implementation of the first aspect, where the first network element is configured to transmit information in the first profile to the second network element; and
the second network element is configured to receive the information in the first profile from the first network element.

In a possible implementation of the first aspect, where the second network element is configured to establish the connection between the fourth network element and the second network element based on the information in the first profile.

In a possible implementation of the first aspect, where the first network element is configured to:
obtain a second profile; and
configure the third network element based on the second profile;
where the second profile includes at least one of a mission profile of the third network element or a reachable address of the fifth network element, where the mission profile is used for indicating an execution of an action in a mission by the third network element, and the reachable address of the fifth network element is used for establishing a connection between the third network element and the fifth network element.

By virtue of the reachable address of the fifth network element, a logical and secured connection between the third network element and such first network element can be established under the control of the first network element, and by virtue of the mission profile, the third network element can be configured with information in the second profile from the fifth network element, thus realizing the configuration of the third network element.

In a possible implementation of the first aspect, where the second profile includes the reachable address of the fifth network element, and the first network element is configured to receive the second profile from the fifth network element.

In a possible implementation of the first aspect, where the second profile includes the reachable address of the fifth network element;
the third network element is configured to receive the second profile from a sixth network element connected to the third network element and forward the second profile to the first network element; and
the first network element is configured to receive the second profile from the third network element.

In a possible implementation of the first aspect, where the second profile includes the reachable address of the fifth network element, and the first network element is configured to receive the second profile from a first basic service to which the fifth network element belongs.

Based on the above, the first network element can receive the reachable address of the fifth network element in various ways, so the reception of the reachable address can be set flexibly according to actual requirements.

In a possible implementation of the first aspect, where the first network element is configured to transmit information in the second profile to the third network element; and
the third network element is configured to receive the information in the second profile from the first network element.

In a possible implementation of the first aspect, where the third network element is configured to establish the connection between the fifth network element and the third network element based on the information in the second profile.

In a possible implementation of the first aspect, the first network element is configured to obtain a gateway deployment profile of network element(s) in the BAS domain in which the first network element is located. Here the network elements can be C/M-TW-GWs or Data-TW-GWs, and the gateway deployment profile may include deployment information (e.g., reachable addresses) of the C/M-TW-GWs or Data-TW-GWs, in this way, connections between C/M-TW-GWs or connections between Data-TW-GWs can be configured by the first network element based on the gateway deployment profile.

In a possible implementation of the first aspect, the first network element is configured to obtain a gateway deployment profile of network element(s) in another BAS domain different from the BAS domain in which the first network element is located. Here the gateway deployment profile can include deployment information (e.g., reachable addresses) about gateways (e.g., C/M-TW-GW(s) and Data-TW-GW(s)) in another BAS domain, which is not limited herein. Upon obtaining such gateway deployment profile, in this way, a logical connection between a C/M-TW-GW under control of the first network element and another C/M-TW-GW in another BAS domain, and/or a logical connection between a Data-TW-GW under control of the first network element and another Data-TW-GW in another BAS domain can be configured by the first network element.

In a possible implementation of the first aspect, the first network element is configured to obtain a gateway deployment profile of network element(s) of third party/parties. Here the gateway deployment profile can include deployment information (e.g., reachable addresses) about gateways of third party/parties, which is not limited herein. Upon obtaining such gateway deployment profile, the first network element can configure a logical connection between a C/M-TW-GW under control of the first network element and a gateway of a third party, and/or a logical connection between a Data-TW-GW under control of the first network element and a gateway of a third party.

In a possible implementation of the first aspect, where the second network element is configured to transmit a first load report to the first network element, where the first load report is indicative of load traffic handled by the second network element; and
the first network element is configured to receive the first load report from the second network element.

In a possible implementation of the first aspect, where the first network element is configured to set an occasion for reporting the first load report by the second network element.

In a possible implementation of the first aspect, where the at least one second network element includes two or more second network elements;
where the first network element is configured to select a further second network element among the two or more second network elements based on first load reports from the two or more second network elements.

In this way, the first network element (e.g., a C/M function which serves as a controller) can acquire the load report of each second network element (e.g., C/M-TW-GW) that it controls and manages, and reconfigure a new C/M-TW-GW in time when the load traffic of the previously configured C/M-TW-GW does not meet the preset threshold, thereby efficiently managing and controlling the C/M-TW-GW and saving system overhead.

In a possible implementation of the first aspect, where the third network element is configured to transmit a second load report to the first network element, where the second load report is indicative of load traffic handled by the third network element; and
the first network element is configured to receive the second load report from the third network element.

In a possible implementation of the first aspect, where the first network element is configured to set an occasion for reporting the second load report by the third network element.

In a possible implementation of the first aspect, where the at least one third network element includes two or more third network elements;
where the first network element is configured to select a further third network element among the two or more third network elements based on second load reports from the two or more third network elements.

In this way, the first network element (e.g., a C/M function which serves as a controller) can acquire the load report of each third network element (e.g., Data-TW-GW) that it controls and manages, and reconfigure a new Data-TW-GW in time when the load traffic of the previously configured Data-TW-GW does not meet the preset threshold, thereby efficiently managing and controlling the Data-TW-GW and saving system overhead.

In a possible implementation of the first aspect, where the first network element is configured to:
instruct the second network element to log interactions between the second network element and the fourth network element; and
the second network element is configured to log the interactions between the second network element and the fourth network element, and report a log result to the first network element.

By logging the interactions between the second network element and the fourth network element by the second network element, the first network element can manage a logical topology of a BAS domain where the first network element is located.

In a possible implementation of the first aspect, where the first network element is configured to:
instruct the third network element to log interactions between the third network element and the fifth network element; and
the third network element is configured to log the interactions between the third network element and the fifth network element, and report a log result to the first network element.

By logging the interactions between the third network element and the fifth network element by the third network element, the first network element can manage a logical topology of a BAS domain where the first network element is located.

In a possible implementation of the first aspect, where the second network element is configured to:
receive a first request message from the fourth network element, where the first request message is indicative of a work requested by the fourth network element; and
determine, based on the first request message, a procedure for implementing the work requested by the fourth network element.

In this way, by virtue of the first request message, the procedure for implementing the work can be determined by the second network element, based on the first request message or based on the first request message and information stored locally in the second network element, action(s) corresponding to the procedure and producer network element(s) which provides/provide a service (e.g., X as a service, XaaS for short) to the fourth network element (as a C/M function entity of a consumer XaaS) can be determined, thereby realizing interaction between the fourth network element and the producer network element with the help of the second network element. In a possible implementation where the second network element is gateway (also referred to as trustworthy gateway or C/M-TW-GW), trustworthiness of the communication from perspectives of operation of the communication system (such as a 6G System) is improved by introducing anonymous service provisioning provided by the trustworthy gateways in the/control/management (C/M) plane.

In a possible implementation of the first aspect, the second network element is configured to monitor signaling exchanging on the established connection between the second network element and the fourth network element, and also log the signaling exchanging, e.g., at which time, with whom the signaling exchanging happened, and how long the signaling exchanging lasts (by recording the starting time and the ending time).

In a possible implementation of the first aspect, the third network element is configured to process a data format of a data packet when transferring the data packet.

In a possible implementation of the first aspect, where the third network element is configured to perform at least one of decryption or encryption operation when transferring a data packet.

By performing the decryption or the encryption operation for the data packet, the security of the data packet in the transmission process can be guaranteed.

In a possible implementation of the first aspect, the third network element is configured to monitor the data exchanging on the established connection between the third network element and the fifth network element, and also log the data exchanging, e.g., at which time, with whom the data exchanging happened, and how long the data exchanging lasts (by recording the starting time and the ending time).

In a possible implementation of the first aspect, where the first network element is communicatively connected to a seventh network element and configured to coordinate processes and data packets exchange on the data plane with the seventh network element.

Based on this, different C/M functions in different BAS domains can communicate directly, and perform data packets exchange via an interface between them.

In a possible implementation of the first aspect, where the first network element is configured to:
obtain a third profile, where the third profile includes reachable addresses of an eighth network element and a ninth network element under control of the seventh network element, and the reachable address of the eighth network element is used for establishing a connection between the second network element and the eighth network element, and the reachable address of the ninth network element is used for establishing a connection between the third network element and the ninth network element;
configure the second network element and the eighth network element to establish the connection between the second network element and the eighth network element; and
configure the third network element and the ninth network element to establish the connection between the third network element and the ninth network element.

Based on this, different C/M-TW-GWs in different BAS domains can communicate with each other, thus facilitating data packets exchanging on the control and management plane.

In a possible implementation of the first aspect, where the first network element is configured to:
receive a first session establishment request, where the first session establishment request is indicative of a first device for which a first session is to be established; and
configure the second network element, based on the first session establishment request, to establish the first session between the first device and the second network element.

By virtue of the first session establishment request, the first network element can determine the first device, the first session for the first device, and the second network element (i.e., the serving C/M-TW-GW); and configure the second network element based the above determined information; thus the first session for the first device can be established, thereby ensuring the information delivering on the control and management plane for the first device. Besides, the information related to the establishment of the first session can be updated to the second service (i.e., SPM service) for securing the first session and updated to the first service (i.e., CM service) for recording the information related to the establishment of the first session.

In a possible implementation of the first aspect, where the first network element is configured to:
receive a second session establishment request, where the second session establishment request is indicative of a first device for which a second session is to be established; and
configure the third network element, based on the second session establishment request, to establish the second session between the first device and the third network element.

By virtue of the second session establishment request, the first network element can determine the first device, the second session for the first device, and the third network element (i.e., the serving Data-TW-GW); and configure the third network element based the above determined information; thus the second session for the first device can be established, thereby ensuring the information delivering on the data plane for the first device. Besides, the information related to the establishment of the second session can be updated to the second service (i.e., SPM service) for securing the second session and updated to the first service (i.e., CM service) for recording the information related to the establishment of the second session.

In a possible implementation of the first aspect, where the at least one second network element includes two or more second network elements, and at least two of the two or more second network elements are communicatively connected.

In a possible implementation of the first aspect, where the at least one third network element includes two or more third network elements, and at least two of the two or more third network elements are communicatively connected.

In the communication system according to the present disclosure, the system includes: a first network element, at least one second network element and at least one third network element; the first network element is communicatively connected to the at least one second network element and the at least one third network element, and configured to control operations of the at least one second network element and the at least one third network element; a second network element of the at least one second network element is communicatively connected to a fourth network element and configured to interact with the fourth network element on a control and management plane; and a third network element of the at least one third network element is communicatively connected to a fifth network element and configured to interact with the fifth network element on a data plane. By managing at least one C/M-TW-GW (second network element) and at least one Data-TW-GW (third network element) by a C/M function (first network element) in the communication system, the following capability/services can be realized: controlling and managing a BAS domain/infrastructure domain/administration domain; enabling interactions among 6G XaaS services provided by same or different partners and enabling interactions between 6G XaaS services and verticals and XaaS services deployed in 3rd party infrastructures/clouds; and providing a capability of anonymous interactions of XaaS services by implementing C/M-TW-GWs and Data-TW-GWs for better trustworthy management.

### BRIEF DESCRIPTION OF THE DRAWINGS

Reference will now be made, by way of example, to the accompanying drawings which show example embodiments of the present disclosure, and in which:

FIG. 1 is a simplified schematic illustration of a communication system according to one or more embodiments of the present disclosure.

FIG. 2 is a schematic illustration of an example communication system according to one or more embodiments of the present disclosure.

FIG. 3 is a schematic illustration of a basic component structure of a communication system according to one or more embodiments of the present disclosure.

FIG. 4 illustrates a block diagram of a device in a communication system according to one or more embodiments of the present disclosure.

FIG. 5 illustrates a block diagram of a 6G System conceptual structure according to one or more embodiments of the present disclosure.

FIG. 6A illustrates a structural schematic of a communication system according to one or more embodiments of the present disclosure.

FIG. 6B exemplarily illustrates a structural schematic of an exemplary communication system according to one or more embodiments of the present disclosure.

FIG. 6C exemplarily illustrates a structural schematic interface of an exemplary communication system according to one or more embodiments of the present disclosure.

FIG. 6D exemplarily illustrates a structural schematic interface of an exemplary communication system according to one or more embodiments of the present disclosure.

FIG. 7A illustrates a schematic flowchart of a connecting process between a second network element and a fourth network element according to one or more embodiments of the present disclosure.

FIG. 7B illustrates a schematic flowchart of an exemplary connecting process between a second network element and a fourth network element according to one or more embodiments of the present disclosure.

FIG. 7C illustrates a schematic flowchart of an exemplary configuration procedure of a second network element (i.e., C/M-TW-GW) according to one or more embodiments of the present disclosure.

FIG. 8A illustrates a schematic flowchart of a connecting process between a third network element and a fifth network element according to one or more embodiments of the present disclosure.

FIG. 8B illustrates a schematic flowchart of an exemplary connecting process between a third network element and a fifth network element according to one or more embodiments of the present disclosure.

FIG. 8C illustrates a schematic flowchart of an exemplary configuration procedure of a third network element (i.e., Data-TW-GW) according to one or more embodiments of the present disclosure.

FIG. 9A illustrates an exemplary first operation mode of a second network element according to one or more embodiments of the present disclosure.

FIG. 9B illustrates an exemplary second operation mode of a second network element according to one or more embodiments of the present disclosure.

FIG. 9C illustrates an exemplary third operation mode of a second network element according to one or more embodiments of the present disclosure.

FIG. 10A illustrates a schematic flowchart of an establishment of a first session for a first device according to one or more embodiments of the present disclosure.

FIG. 10B illustrates a schematic flowchart of another establishment of a first session for a first device according to one or more embodiments of the present disclosure.

FIG. 11A illustrates a schematic flowchart of an establishment of a second session for a first device according to one or more embodiments of the present disclosure.

FIG. 11B illustrates a schematic flowchart of another establishment of a second session for a first device according to one or more embodiments of the present disclosure.

### DETAILED DESCRIPTION OF THE ILLUSTRATIVE EMBODIMENTS

To describe the technical solutions in embodiments of the present disclosure or in the prior art more clearly, the following briefly introduces the accompanying drawings needed for describing the embodiments or the prior art.

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

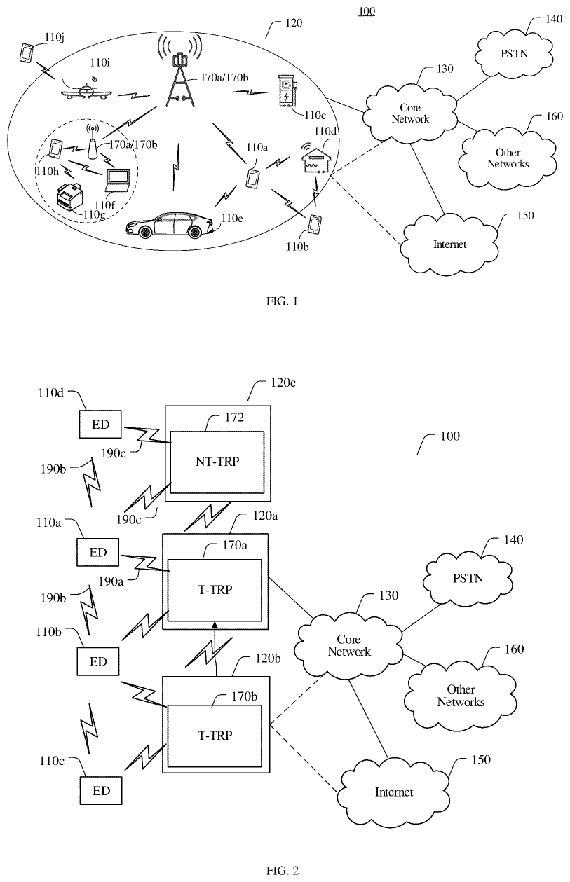

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

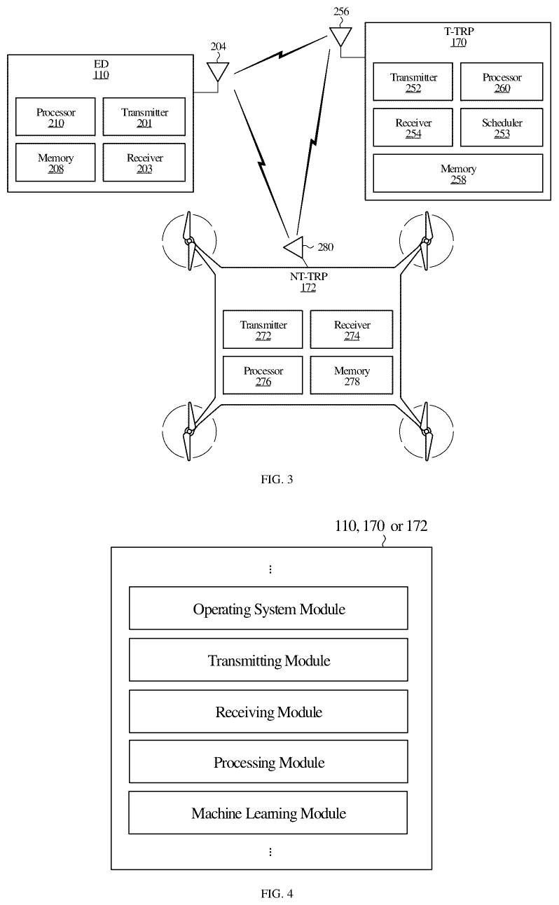

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

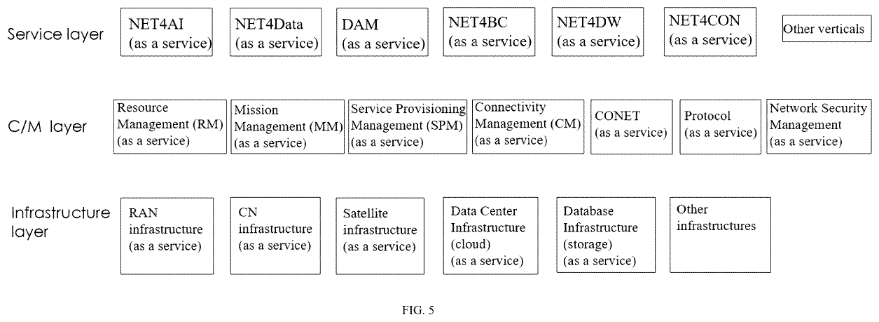

FIG. 3 illustrates another example of an ED 110 and a base station 170a, 170b and/or 170c. The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is transmitted by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control—Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

### Basic Module Structure

One or more steps of the embodiment methods provided herein may be performed by corresponding units or modules, according to FIG. 4. FIG. 4 illustrates units or modules in a device, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

### 6G Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The air interfaces may also use UWB technology to perform sensing of the surrounding environment using UWB signals.

The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, high rate pulse repetition frequency (HRP) UWB waveform, low rate pulse repetition frequency (LRP) UWB waveform and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

The solution described in the present disclosure may be applicable to a next generation (e.g. sixth generation (6G) or later) network, or a legacy (e.g. 5G or 4G) network.

The proposed System architecture is defined to support 6G X as a service (XaaS service) by using techniques such as Network Function Virtualization and Network Slicing. The 6G System architecture utilizes service-based interactions between next generation services.

The System leverages service-based architecture and XaaS concept. XaaS services in the 6G System are categorized into three layers. The 6G System conceptual structure is shown in FIG. 5.

Infrastructure Layer includes infrastructures supporting 6G services. Among them are wireless networks (RAN, CN) infrastructures, Cloud/data center infrastructures, satellite networks, storage/database infrastructures, and sensing networks, and etc. These infrastructures can be provided by a single provider or by multiple providers.

Each of the infrastructures could have its control and management functions, denoted as C/M functions, for infrastructure management. Each of these infrastructures is one type of Infrastructure as a Service.

Control and Management (C/M) layer includes control and management services of the 6G System. They are developed and deployed by using slicing techniques and utilizing resource provided by infrastructure layer. 6G services in Control and Management (C/M) layer are:
Resource Management (RM) as a Service provides a capability of life-cycle management of a variety of slices and over-the-air resource assignment to wireless devices.
Mission Management (MM) as a Service provides a capability to program provisioning of XaaS services at Service Layer to provide mission services.
Confederation Network (CONET) as a Service provides a capability to enable multiple partners jointly provide 6G services. This capability is provided by confederation formation, mutual authentication, mutual authorization among partners and negotiation of agreement on recording and retracing of selected actions performed by partners, in order to assure a trustworthy environment of 6G System operations.
Service Provisioning Management (SPM) as a Service provides a capability of control and management of 6G service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world.
Connectivity Management (CM) as a Service leverages 5G connectivity management functions, but with extension to include digital world.
Protocol as a Service provides a capability to design service customized protocol stacks for identified interfaces. The protocol stacks could be pre-defined for on-demand selection, or could be on-demand designed.
Network Security as a Service provides a capability for owners of infrastructures to detect potential security risks of their infrastructures.

A 6G mission is defined as a service provided to customers by the 6G System. A mission can be a type of services which is provided by a single 6G XaaS service or a type of services that needs contributions from multiple XaaS services.

XaaS services in C/M Layer support control and management of the 6G System itself and also provide support to verticals if requested. One example is that RM service can serve RAN for over-the-air resource management and can also provide service to a vertical for the vertical's over-the-air resource allocation to its end-customers. The XaaS in C/M layer can be deployed by using slicing technique.

Service Layer includes 6G services which provide services to customers. In the 6G System conceptual structure:
AI service may be denoted as NET4AI as a Service. Artificial Intelligence service provides AI capability to support a variety of AI applications.
Service of data collection, data sanitization, data analysis and data delivery are denoted as DAM as a Service, this service provides a capability of lifecycle management of statistic data, including acquisition, de-privatization, analysis and delivery of data which are information statistic data from any types of sensors, devices, network functions, and etc.
Service of storage and sharing of data may be denoted as NET4Data as a Service, this service provides a capability to trustworthily storage and share data under the control of owners of data and following recognized authorities'regulations on control of identified data.
Service to provide digital world may be denoted as NET4DW as a Service, Digital World service provides a capability to construct, control and manage digital world. Digital world is defined as digital realization of physical world.
6G block chain service may be denoted as NET4BC as a Service. 6G connectivity service is denoted as NET4Con as a Service. This service provides a capability to support 6G block chain services.
Enhanced connectivity service, e.g., network for connectivity (NET4CON) as a service. This service provides a capability to support exchange of messages and data among new 6G services.

All XaaS services at this Layer are developed and deployed by using resource provided in infrastructure and utilizing Network Function Virtualization and Slicing techniques. The capability of each of 6G services is provided by its control and management functions and service specific data process functions.

In addition to support 6G XaaS services at Service Layer, 6G System leverages 5G System for provisioning of vertical services. The difference between 6G XaaS services and other verticals are that a vertical is a pure customer which needs other XaaS services to enable its operation, while each of XaaS services provide their capabilities to 6G customers.

Any pair of XaaS services of the 6G System could also be mutual customer and provider of each other. Some of examples are that an infrastructure owner provides its resource to XaaS services in Service Layer and C/M Layer; RM services may need the capabilities provided by NET4AI, DAM and NET4DW for its resource management for vertical slicing; CONET service and NET4Data service may need the capability provided by NET4BC for their operation.

In a XaaS service module, there are one or multiple network functions, these network functions can be classified into two categories: C/M function is used for control and management, data processing function (also can be referred to as data function) is used for processing data, the data processing function is only existed in the XaaS services at the service layer.

The key concepts of 6G System includes:
Define Basic XaaS Services by decoupling comprehensive types of services into basic XaaS services. A basic XaaS service provides unique capability to enable a specific type of service, such as NET4AI service, NET4DW service, DAM service, NET4Data service, Block chain service, mission management service, etc.
Allow joint operation of the 6G System by multiple partners.
Define Data Plane of the 6G System which includes processing functions of data plane of XaaS services. Programing the interconnection of these functions, by mission management service, enables to support a variety of customized customer services. Data plane defined in 6G system is a collection of data processing functions of XaaS service in service layer, used for processing and transmitting data plane traffic. Types of traffic data in 6G system include: training model in NET4AI services, raw data collected, post-sanitized data in DAM service, data in NET4Data, data within digital world in NET4DW, data blocks in NET4BC.
Simplify 6G System architecture by categorizing basic control services and management services and combining them as basic XaaS services in Control and Management (C/M) Layer.
Define C/M Plane of the 6G System which includes C/M functions in XaaS services and may include 5G CP (e.g., AMF) depending on implementation options. C/M Plane of the 6G System is defined as a collection of C/M functions of XaaS services in the 6G System Conceptual Structure and used for C/M plane messages exchange among XaaS services.
Simplify SBI interfaces by introducing trustworthy GWs in Data Plane and C/M Plane of the 6G System. The C/M-TW-GW (Control/Management plane TrustWorthy GateWay) provides the abilities of control plane connectivity, anonymous communication, and secure communication, to enable these abilities, the C/M-TW-GW provides following functionalities: establishes and maintains secured tunnel with each of XaaS services, performs decryption and encryption operation when transferring C/M plane message; maintains an authorization profile for each of XaaS services; transfers the C/M plane message. The Data-TW-GW (Date plane TrustWorthy GateWay) provides the abilities to connect data plane functions of XaaS services to enable to anonymous and secured data plane interaction among XaaS services, the Data-TW-GW provides following functionalities: establishes and maintains secured tunnel with each of XaaS services, performs decryption and encryption operation when transferring data packets; data format translation; transfers the data packets.
Define Basic Architecture Structure (BAS) which is a unified basic structure with minimized number of interfaces and is independent of types of infrastructures. A BAS is a collection of XaaS services (including C/M plane functions and data plane functions), TW-GWs in both C/M plane and data plane, and the interfaces between these functions. An infrastructure network that implements a single 6G System BAS is defined as a BAS domain. Each of RAN, CN, a cloud infrastructure, or a wireless device could be a BAS domain.
Simplify standardization, development and deployment of the 6G System using the BAS concept, while supporting a variety of infrastructure deployment scenarios.
Adapt to a variety of deployment scenarios by applying the BAS or a subset of it to infrastructures based on capability, capacity and requirement of the infrastructure networks.
Leverage SBI interface concept and apply SBI interaction in both 6G C/M plane and 6G data plane.—Improve trustworthiness from perspectives of operation of the 6G System by introducing CONET capability, NET4BC capability and anonymous service provisioning provided by the trustworthy GWs in the C/M plane and data plane of the 6G System.
Improve trustworthiness from perspective of end customer privacy protection by unified mutual authentication, IDM, data sanitization and etc. provided by SPM service, DAM service and 6G Block Chain service.
Simplify roaming management of wireless devices, in physical world and digital world, by unified authentication including all participated partners and customers.
Support multiple development paths from 5G System to 6G System by defining multiple architecture options without incurring much efforts due to the introduction of the BAS concept.
Support backward compatibility by utilizing benefits of SBA and its add-on feature. 5G users can use the 6G System to access 5G services.
Support future extension by adding new XaaS services with minimized impact on standardization and deployment, due to the introduced anonymous service provisioning concept implemented in trustworthy GWs in 6G C/M plane and in 6G data plane.

In the existing art, 5G system and O-RAN don't have the proposed 6G network architecture. 5G system CP SBI uses SCP and NRF, etc., to support 5G CP plane indirect communication but not support strong trustworthiness. 5G system has no Data plane definition and has no Data-TW-GW concept. O-RAN has near-term RIC and long term RIC which are not solving issues that 6G may be facing.

Many new trends will trigger the consideration and design of 6G/future wireless networks:
New network infrastructure capability, e.g., cloud natured/friendly infrastructures that are broadly deployed.
New (relative) matured techniques, e.g., AI large scale models, Data de-privacy, Block chain, etc. that have made significant progresses and significantly impact on the entire society and human life.
New apps and services, e.g., AI services, Data (sensing) service, Digital world service, etc. that are broadly applied in industry/business and used by individual customers.
More global/open/collaborative operation trend, i.e., a more open and more collaborative operation mode are becoming common practice in many fields.

New expectation and stricter requirements on future networks also drive rethinking and development of new generation of wireless networks. These requirements include
Privacy and trustworthiness, etc.
simplified standardization.
Rapid deployment.
Etc.

All of the above drives 6G network architecture research work.
The proposed 6G network architecture (X-centric) are SBA (XaaS service) based and Cloud-native.

Requirements to 6G System network architecture design:
The proposed 6G network architecture needs to support new 6G services which could be developed/deployed by 3rd parties.
The proposed 6G network architecture needs to embrace more open ecosystem to open door to technical capable 3rd parties.
The proposed 6G network architecture needs to enable better trustworthiness management.

The proposed 6G network architecture may enable controlled anonymous interactions among multiple players.

In the present disclosure, a service framework is proposed, which is expected to meet the above new requirements to 6G networks.

The proposed service framework owns C/M-TW-GWs and Data-TW-GWs and manages these GWs. The service framework provides following capability/services:
controlling and managing a bas domain/infrastructure
domain/administration domain.
enabling interactions among 6G XaaS services provided by same or different partners and enabling interactions between 6G XaaS services and verticals and XaaS services deployed in 3rd party infrastructures/clouds.
providing a capability of anonymous interactions of XaaS services by implementing C/M-TW-GWs and Data-TW-GWs for better trustworthy management.

This service framework could be provided by owners of infrastructures, e.g., RAN providers, CN providers, and etc.

The solution described in the present disclosure is applicable to future 6G networks.

The proposed C/M-TW-GW and Data-TW-GW could be key potential for 6G products.

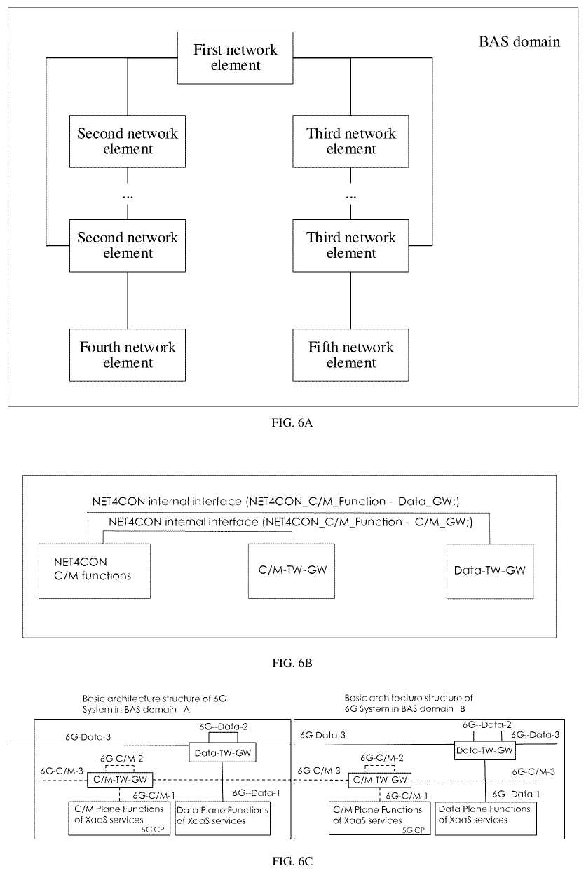

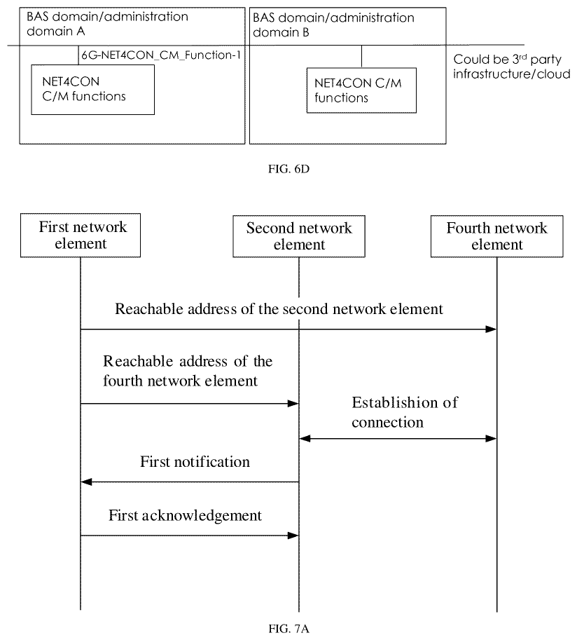

FIG. 6A illustrates a structural schematic of the above service framework (which is also referred to as communication system below) according to one or more embodiments of the present disclosure. The communication system includes:
a first network element, at least one second network element and at least one third network element; the first network element is communicatively connected to the at least one second network element and the at least one third network element, and configured to control operations of the at least one second network element and the at least one third network element; a second network element of the at least one second network element is communicatively connected to a fourth network element and configured to interact with the fourth network element on a control and management plane; and a third network element of the at least one third network element is communicatively connected to a fifth network element and configured to interact with the fifth network element on a data plane.

The first, second and third network elements are three kinds of logical network elements, where the first network element can be a C/M function in a BAS domain, the second network element can be a C/M-TW-GW (control/management plane trustworthy GW) in the BAS domain, and the third network element can be a Data-TW-GW (Data plane trustworthy GW) in the BAS domain, there can be one C/M function, at least one C/M-TW-GW and at least one Data-TW-GW in one BAS domain or one administration domain (or referred to as domain for short). It should be noted that although one domain is shown in FIG. 6A, the number of domains is not limited in the embodiments of the present disclosure.

The first network element controlling the operations of the at least one second network element and the at least one third network element can be, for example, the C/M function in the BAS domain controls and manages topology of the BAS domain, e.g., logical connections between XaaS services/verticals and GWs (including C/M-TW-GWs and Data-TW-GWs) in such a domain, XaaS services have their own C/M function entities (for realizing their C/M functions of XaaS service modules) and data function entities (for realizing their data processing functions of XaaS service modules) in the same BAS domain as the C/M function, verticals also have their own C/M function entities and data function entities in the same BAS domain as the C/M function, the C/M-TW-GW under control of the C/M function in the BAS domain provides capabilities to connect the C/M function entities of XaaS services and verticals in a BAS domain, so as to enable anonymous and secured C/M plane interaction among XaaS services following authorization profiles of XaaS services, as well as anonymous and secured C/M plane interaction among verticals. The Data-TW-GW under control of the C/M function in the BAS domain provides capabilities to connect the data function entities of XaaS services and verticals in a BAS domain, so as to enable anonymous and secured data plane interaction among XaaS services, as well as anonymous and secured data plane interaction among verticals to manage assured service performance. In addition, for example, the second network element may serve as a serving C/M-TW-GW of a 6G device/D-User/any type of customer, the third network element may serve as a serving Data-TW-GW of the 6G device/D-User/any type of customer, the C/M function also manages a C/M session and/or a data session to control the 6G device/D-User/any type of customer to access the communication system. Here the C/M session may be a secured logical connection established between the 6G device/D-User/any type of customer and its serving C/M-TW-GW (the second network element) and is used for signaling exchanging there between on the C/M plane; and the data session may be a secured logical connection established between the 6G device/D-User/any type of customer and its serving Data-TW-GW (the third network element) and is used for data exchanging there between on the data plane.

In a possible implementation, the fourth network element can be a C/M function entity of a XaaS service or a vertical in the BAS domain. In a possible implementation, the fifth network element can be a data function entity of a XaaS service or a vertical in the BAS domain.

For the concept of the XaaS service, reference can be made to the related description in FIG. 5, and will not be repeated here. The difference between the XaaS service and the vertical is that the vertical is a pure customer which needs other XaaS services to enable its operation, while the XaaS service provides its capabilities to 6G customers.

The aforementioned C/M function entity of the XaaS service performs control and management plane functions that are for purpose of network control and management, and also supports signaling exchanging of the XaaS service on the C/M plane. Different C/M function entities may be connected via the C/M-TW-GW for supporting anonymous and secured C/M plane interaction among XaaS services.

The aforementioned data function entity of the XaaS service can be a processer which processes data plane traffic, such as NET4AI entity is for model training, etc., and also supports data exchanging of the XaaS service on the data plane. Different data function entities may be connected via the Data-TW-GW for supporting anonymous and secured data plane interaction among XaaS services.

The vertical is a business or industry customer, which is different from an individual wireless device. It could have its dedicated network resource, or integrate its self-defined functions with network functions, could have its own customers, etc. For example, the vertical here may be a kind of service running on the basis of a network provided by e.g., an operator, the vertical per se normally does not own such a network, but may also be able to provide a service to users based on the network, so from the perspective of the operator, such service can be regarded as a vertical. For example, some chatting applications do not have their networks, but can also provide services to users, these chatting applications can be regarded as verticals. The vertical may also have its own server(s), and its own C/M function entity/entities and data function entity/entities, so in order to make it possible for the vertical to provide a service to users, the C/M-TW-GW and the C/M function entity of the vertical needs to be connected and the Data-TW-GW and the data function entity of the vertical needs to be connected. It should be noted that although examples in the following description are shown with respect to C/M and data entities of XaaS service, but they would also be applicable for C/M and data entities of the vertical.

In a possible implementation, the at least one second network element includes only one second network element, the aforementioned second network element of the at least one second network element refers to the only one second network element, and this second network element is communicatively connected to a fourth network element.

In a possible implementation, the at least one second network element includes two or more second network elements, and at least two of the two or more second network elements are communicatively connected. For example, different C/M-TW-GWs (some or all of the C/M-TW-GWs of the BAS domain) in the same BAS domain may be connected. In this case, the aforementioned second network element of the at least one second network element may refer to one or more second network elements of the two or more second network elements, and each of the one or more second network elements can be communicatively connected to a fourth network element directly or indirectly (via another second network element). For example, it is not necessary for all C/M-TW-GWs to each connect to a C/M function entity of a XaaS service in the BAS domain, it should be noted that the solution of the present disclosure is also applicable for the case where each of the one or more second network elements is communicatively connected directly to a fourth network element, although the case where each of the one or more second network elements is communicatively connected to a fourth network element is shown in FIG. 6A in a direct or indirect way.

In a possible implementation, the at least one third network element includes only one third network element, the aforementioned third network element of the at least one third network element refers to the only one third network element, and this third network element is communicatively connected to a fifth network element.

In a possible implementation, the at least one third network element includes two or more third network elements, and at least two of the two or more third network elements are communicatively connected. For example, different Data-TW-GWs (some or all of the Data-TW-GWs of the BAS domain) in the same BAS domain may be connected. In this case, the aforementioned third network element of the at least one third network element may refer to one or more third network elements of the two or more third network elements, and each of the one or more third network elements is communicatively connected to a fifth network element directly or indirectly (via another third network element). For example, it is not necessary for all Data-TW-GWs to each connect to a data function entity of a XaaS service in the BAS domain, it should be noted that the solution of the present disclosure is also applicable for the case where each of the one or more third network elements is communicatively connected directly to a fifth network element, although the case where each of the one or more third network elements is communicatively connected to a fifth network element is shown in FIG. 6A in a direct or indirect way.

The following will describe a specific example of the communication system with reference to FIG. 6B-6D, the communication system can be a service framework, which owns a C/M-TW-GW and a Data-TW-GW. It should be noted that one C/M-TW-GW and one Data-TW-GW are shown as an example for illustrative purpose, and any number of C/M-TW-GWs and Data-TW-GWs can be configured according to actual needs. The NET4CON C/M function(s) can be the aforementioned first network element(s), the C/M-TW-GW can be the aforementioned second network element, the Data-TW-GW can be the aforementioned third network element.

Capability/service provided by the service framework are as follows:
controlling and managing a BAS domain/infrastructure domain/administration domain.
enabling interactions among 6G XaaS services provided by same or different partners and enabling interactions between 6G XaaS services and verticals and XaaS services deployed in 3rd party infrastructures/clouds.
providing a capability of anonymous interactions of XaaS services by implementing C/M-TW-GWs and Data-TW-GWs for better trustworthy management.

This service framework could be provided by owners of infrastructures, e.g., RAN providers, CN providers, and etc.

The service framework (in one BAS domains or one administration domain) consists of the followings:
Logical Elements, including:
NET4CON C/M function;
C/M-TW-GW(s);
Data-TW-GW(s).
Internal interfaces, including:
NET4CON_C/M_function—C/M-TW-GW;
NET4CON_C/M_Function—Data-TW-GW;
External interfaces, including:
Interfaces related to C/M-TW-GWs, such as 6G-C/M-1, 6G-C/M-2 and 6G-C/M-3, which will be described below in detail.
Interfaces related to Data-TW-GWs, such as 6G-Data-1, 6G-Data-2 and 6G-Data-3.
Interfaces related to C/M functions, such as NET4CON-NET4CON and External-NET4CON.
Serving C/M-TW-GW, which is one of the above C/M-TW-GWs and is an endpoint on the network side for a C/M session of the device (such as 6G device), and the device uses the C/M session to communicate with the communication system.
Serving Data-TW-GW, which is one of the above Data-TW-GWs and is an endpoint on the network side for a data session of the device (such as 6G device), and the data session is used for data plane packets exchange between the device and the communication system.

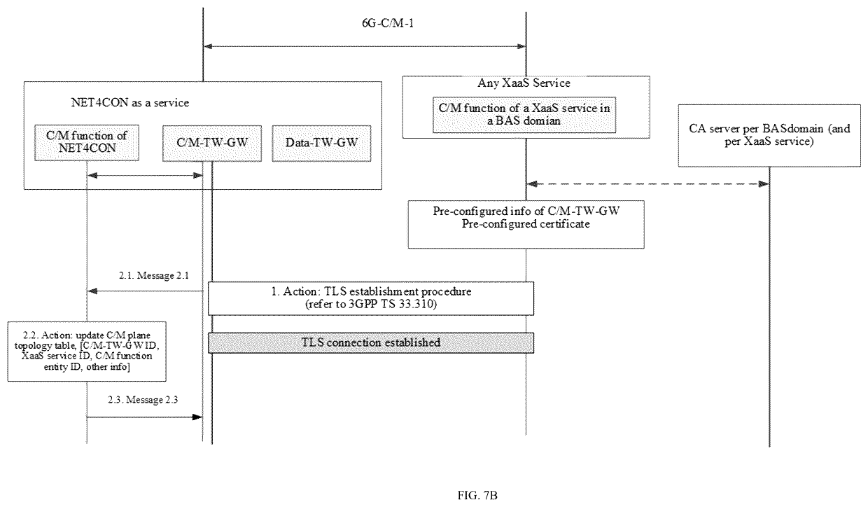

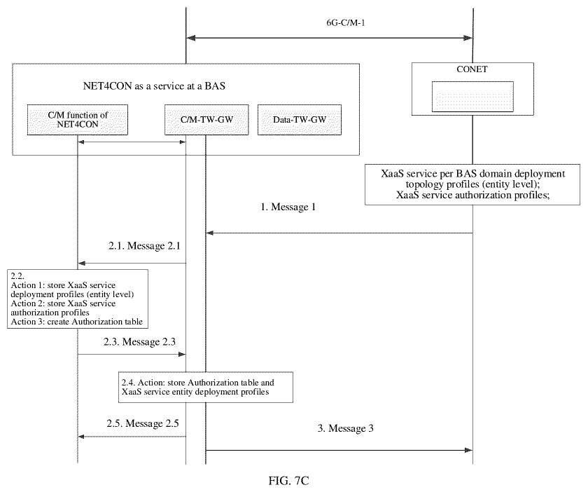

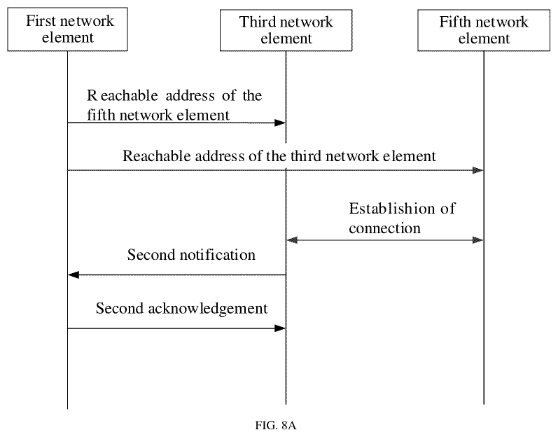

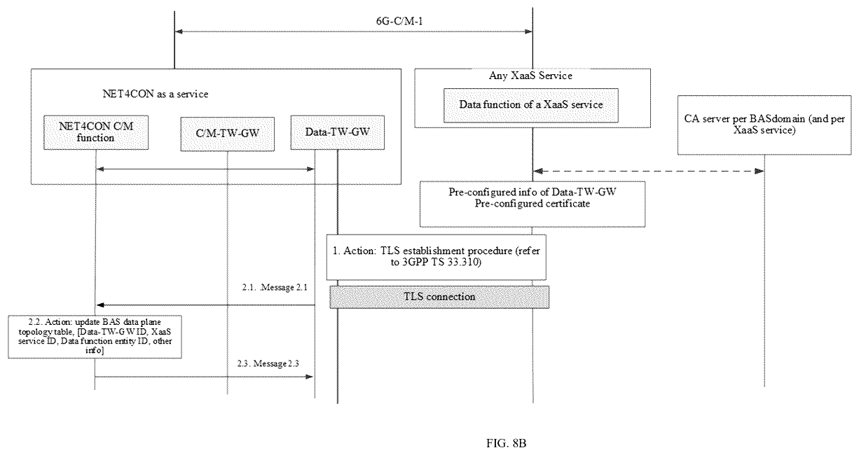

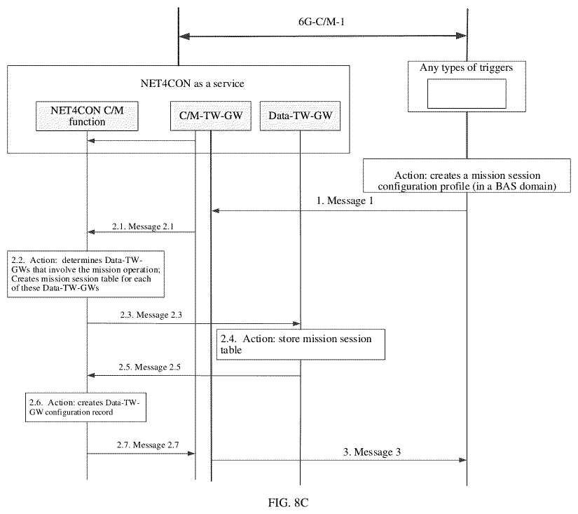

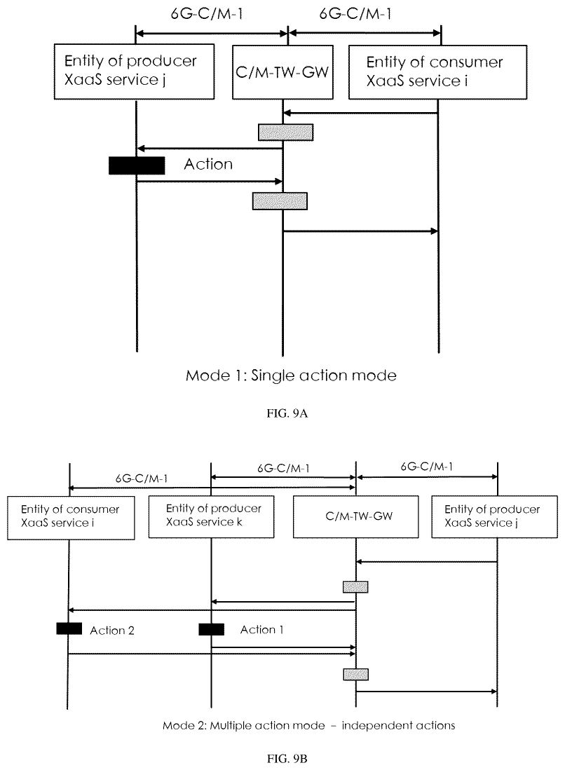

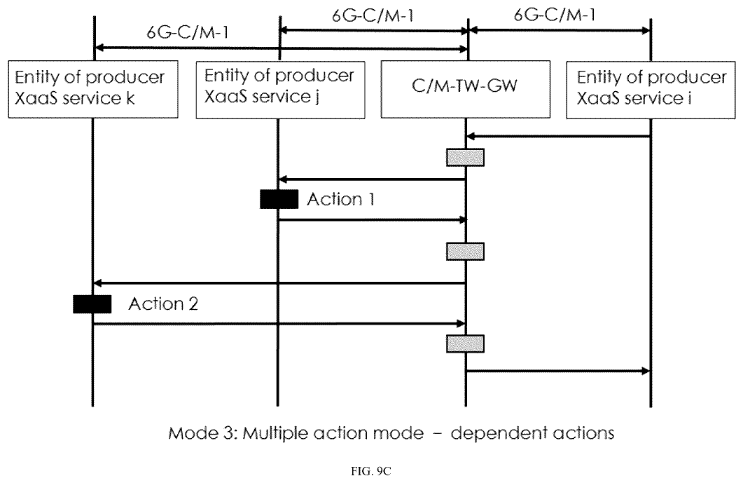

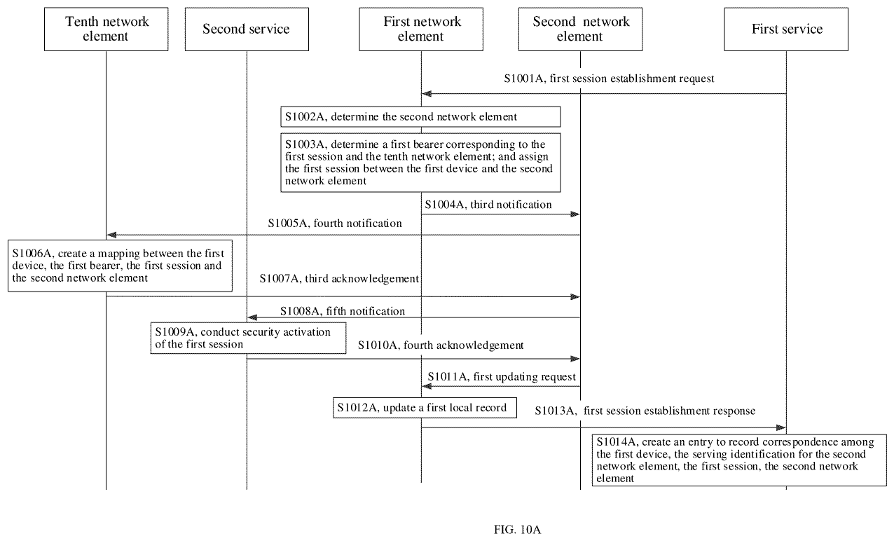

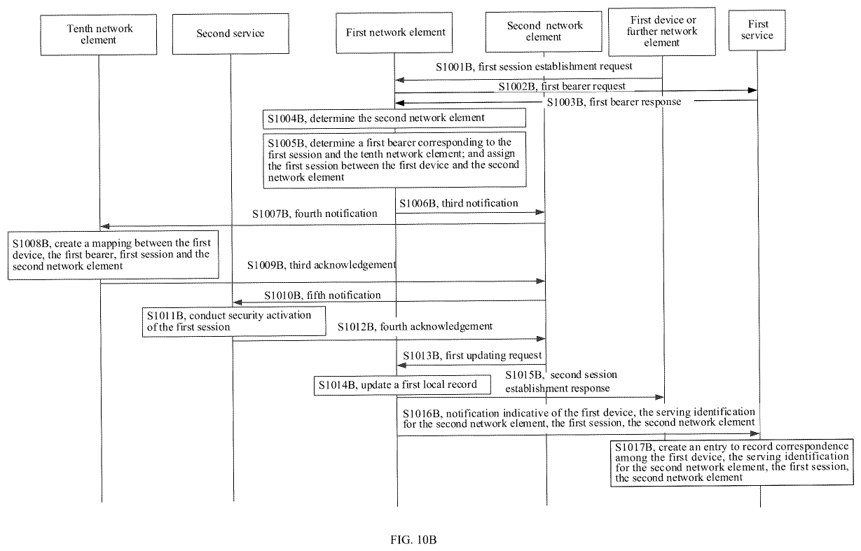

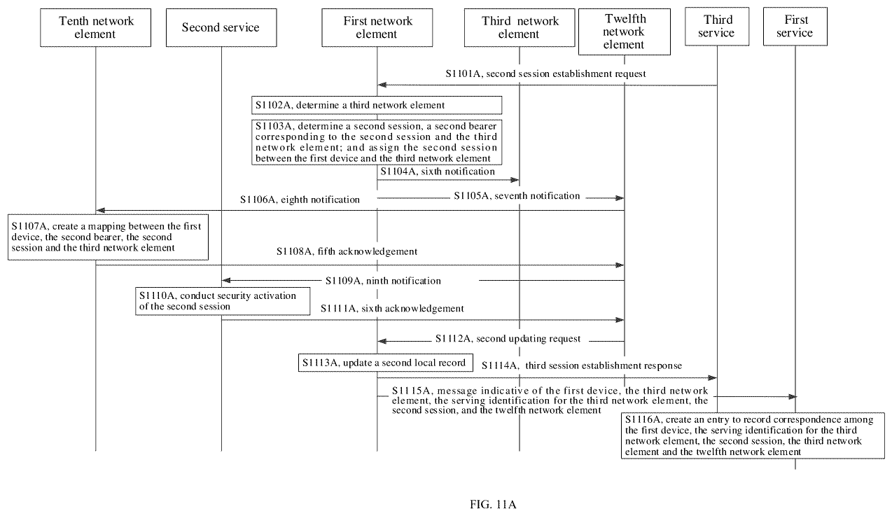

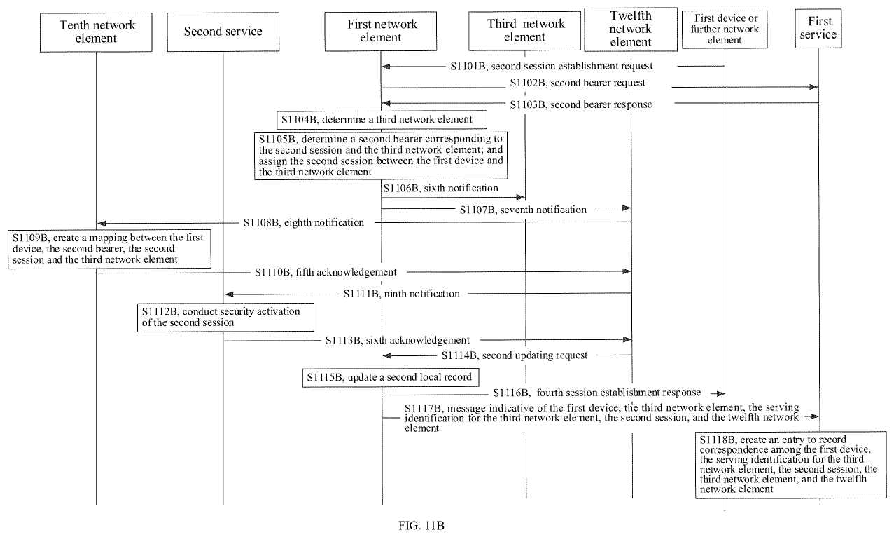

The C/M function is responsible for the followings (not limited to):
Information acquisition (examples will be given below with reference to FIGS. 7A-7C and FIGS. 9A-9C)
Obtaining XaaS service deployment profile from external (e.g., CONET, XaaS services, etc.).
   Obtaining XaaS service authorization profile.
   Obtaining deployment of GWs.
Managing a BAS/administration domain logical topology (examples will be given below with reference to FIGS. 7A-7C and FIGS. 8A-8C)
   Configuring GWs for setting up secured connections among these GWs, including 3rd parties'GWs, this can be done by using the obtained GW deployment of GWs in other BAS domains;
   Configuring C/M-TW-GWs and C/M plane function entities (which is also referred to as C/M function entities) of XaaS services in a BAS domain for setting up secured connections;
   Configuring C/M-TW-GWS on authorization profiles of XaaS services and deployment profiles of XaaS services;
   Configuring C/M-TW-GWs and Verticals for setting up secured connections between the C/M-TW-GWs and verticals when needed.
   Configuring Data-TW-GWs and data plane function entities (which is also referred to as data function entities) of XaaS services in a BAS domain for setting up secured connections.
   Configuring Data-TW-GWs and verticals for setting up secured connections between the Data-TW-GWs and verticals when needed.
Managing a C/M session and a data session for a mobile device and a D-User (anchor) in NET4DW (examples will be given below with reference to FIGS. 10A-10B and FIGS. 11A-11B)
   Controlling the establishment of the C/M session (logical connection between a device and its serving C/M-TW-GW) for the device;
   Controlling the establishment of the data session (logical connection between a device and its serving Data-TW-GW) for the device;
   Maintaining information for the device on it serving C/M session and data session and mappings between RBs and sessions.
Managing log and load of the C/M-TW-GWs and the Data-TW-GWs
   Configuring the C/M-TW-GWs and the Data-TW-GWs on logs of interactions of XaaS services on C/M plane and data plane;
   Tracking load status of the C/M-TW-GWs and the Data-TW-GWs;
   Managing load balance of the GWs by tearing down current secured connections of the XaaS service functions from some of the GWs and re-establish secured connections with other GWs.
   Etc.

The C/M-TW-GW is responsible for providing capabilities to connect the C/M function entity/entities of the XaaS services and verticals in the BAS/infrastructure domain, in order to enable anonymous and secured C/M plane interaction among the XaaS services, following the authorization profiles of the XaaS services.

The C/M-TW-GW function is responsible for the followings (not limited to):
Receiving configuration from C/M functions or other entities and maintains authorization profiles of XaaS services and managing a local Active authorization table to control authorization for XaaS service consumers and providers
Receiving configuration from C/M functions or other entities and maintaining deployment profiles of XaaS services;
Establishing and maintaining one secured tunnel with each of XaaS services and verticals in a BAS/infrastructure domain.
Performing security tunnel related operations.
Performing Lawful C/M plane message inspection and message log
Recording load of each of such tunnels to enable load management.
Conducting multiple operation modes in procedures of C/M plane messages exchanges among XaaS services, which will be described in detail below with reference to FIGS. 9A-9C.

The Data-TW-GW is responsible for providing capabilities to connect the data function entity/entities of the XaaS service(s) and the vertical(s) in the Basic Architecture Structure domain (BAS)/infrastructure domain, to enable anonymous and secured data plane interaction among the XaaS service(s) and to manage assured service performance.

The Data-TW-GW is responsible for the followings (not limited to):
Establishing and maintaining one secured tunnel with data plane function(s) of each of XaaS services and verticals in a BAS domain/infrastructure domain.
Receiving configuration for data packets exchange among XaaS services.
Recording load of each of such tunnels and updated to NET4CON C/M function to enable load management.
Performing decryption and encryption operation when transferring data packets in case needed;
Data format translation to enable the data function entity of the XaaS service understand the format of data received.
Processing protocol processing for QoS and routing based on configuration by mission management or be carried in protocol stacks. For the latter case, the Data-TW-GW processes the protocol headers and performs corresponding QoS handling and routing operation.
Logging traffic, based on configuration, to support network operation optimization, service performance assurance and charging.
Performing lawful inspection, under configuration.
Etc.

The above three types of logical network elements are connected with each other through interfaces. For example, with respect to the same BAS domain, the C/M function can be respectively connected to a C/M-TW-GW and a Data-TW-GW; different C/M-TW-GWs in the same BAS domain can be connected, different Data-TW-GWs in the same BAS domain can be also be connected, the C/M-TW-GW and a C/M function entity of a XaaS service in the same BAS domain can be connected, and the Data-TW-GW and a Data function entity of a XaaS service in the same BAS domain can be connected.

For another example, with respect to different domains, a C/M-TW-GW in one BAS domain and another C/M-TW-GW in another BAS domain can be connected, a Data-TW-GW in one BAS domain and another Data-TW-GW in another BAS domain can be connected, and different C/M functions in different domains can also be connected.

The above service framework serves as a service (NET4CON service), one first network element (C/M function), one or more second network elements (C/M-TW-GW), and one or more third network elements (Data-TW-GWs) included in the service framework are for implementing the NET4CON service in one BAS domain. The NET4CON service to which the first, second and third network elements belong and the service (XaaS service) to which the fourth and fifth network elements belong are different services, where the NET4CON service is used for providing connecting capabilities among entities of XaaS services, and the NET4CON service is used herein only for illustration, it can also be called by other names, which is not limited in the embodiments of the present disclosure. The C/M function throughout the text refers to the C/M function of the NET4CON service unless otherwise indicated.

The interfaces related to the above connections of the logical network elements will be described in detail. For a NET4CON service, the internal interfaces are specified as interfaces between the C/M function and the C/M-TW-GW in the same domain under control of the C/M function, and between the C/M function and the Data-TW-GW in the same domain under control of the C/M function, all interfaces other than the internal interfaces are called external interfaces. That is, the external interfaces of the NET4CON service include interfaces between the NET4CON service and other XaaS services and functions implemented in 3rd party infrastructures, as well as interfaces between different C/M-TW-GWs and interfaces between different Data-TW-GWs.

Still referring to FIG. 6B, the C/M function can be connected with the C/M-TW-GW or the Data-TW-GW in the same BAS domain via an internal interface, where the C/M function and the C/M-TW-GW are connected via Interface NET4CON_C/M_Function-C/M_GW, the C/M function and the Data-TW-GW are connected via Interface NET4CON_C/M_Function-Data_GW. Specifically:
Interface NET4CON_C/M_Function—C/M_GW is used (not limited to):
   For the C/M function to configure C/M-TW-GWs, including XaaS service deployment profiles, XaaS service authorization profiles, etc.;
   For the C/M function to configure a C/M-TW-GW as a serving C/M-TW-GW of one device/D-user;
   For a C/M-TW-GW to forward some C/M messages to C/M function for decision making (e.g., serving C/M-TW-GW selection for a devices, etc.);
   For C/M function to send its decision types of message to a C/M-TW-GW;
   For a C/M-TW-GW to Report its Logged Load Information for Load management by C/M function;
   Etc.
Interface NET4CON_C/M_Function-Data_GW is used (not limited to):
   For C/M function to configure Data-TW-GWs, including XaaS service deployment profiles, (optional) XaaS service authorization profiles, etc.;
   For C/M function to configure a Data-TW-GW as a serving Data-TW-GW of one device/D-user;
   For a Data-TW-GW to report its logged load information for load management by C/M function;
   Etc.

The connection between different C/M-TW-GWs in the same BAS domain, the connection between different Data-TW-GWs in the same BAS domain, the connection between the C/M-TW-GW and the C/M function entity of a XaaS service in the same BAS domain, the connection between the Data-TW-GW and the Data function entity of a XaaS service in the same BAS domain, the connection between different C/M-TW-GWs in different BAS domains, the connection between different Data-TW-GWs in different BAS domains, the connection between a C/M-TW-GW and a C/M function entity implemented in a 3rd party infrastructure, the connection between a Data-TW-GW and a data function entity implemented in a 3rd party infrastructure, can be made via external interfaces. These interfaces are shown in FIG. 6C.

As shown in FIG. 6C, a C/M-TW-GW and a C/M function entity of a XaaS service (i.e., C/M plane function of a XaaS service shown in FIG. 6C) in the same BAS domain (for example, BAS domain A or BAS domain B) are connected via an external interface 6G-C/M-1; different C/M-TW-GWs in the BAS domain A are connected via an external interface 6G-C/M-2; different C/M-TW-GWs in the BAS domain B are connected via an external interface 6G-C/M-2; and a C/M-TW-GW in the BAS domain A and a C/M-TW-GW in the BAS domain B are connected via an external interface 6G-C/M-3. Similarly, a Data-TW-GW and a data function entity of a XaaS service (i.e., data plane function of a XaaS service shown in FIG. 6C) in the same BAS domain (for example, BAS domain A or BAS domain B) are connected via an external interface 6G-Data-1; different Data-TW-GWs in the BAS domain A are connected via an external interface 6G-Data-2; different Data-TW-GWs in the BAS domain B are connected via an external interface 6G-Data-2; and a Data-TW-GW in the BAS domain A and a Data-TW-GW in the BAS domain B are connected via an external interface 6G-Data-3.

Interface 6G-C/M-1 is used for:
receiving and sending C/M plane messages between a C/M-TW-GW and a C/M function entity (which is also referred to as C/M function) of a XaaS service;
enabling interaction between C/M function entities of different XaaS services.

Interface 6G-C/M-2 is used for:
interaction between C/M-TW-GWs within a BAS/infrastructure domain.

Interface 6G-C/M-3 is used for:
interaction between C/M-TW-GWs belong to different BAS/infrastructure domains;
interaction with 3rd party's control/management functions, for a C/M-TW-GW which connects with 3rd party cloud, e.g. For information exposure, etc.

Interface 6G-Data-1 is used for:
receiving and sending data plane packets between a Data-TW-GW and a Data function entity (which is also referred to as data function) of a XaaS service;
enabling data packets exchange between data process function entities of different XaaS services.

Interface 6G-Data-2 is used for:
interaction between Data-TW-GWs within a BAS/infrastructure domain.

Interface 6G-Data-3 is used for:
interaction between Data-TW-GWs belong to different BAS/infrastructure domains.
interaction with 3rd party's data plane functions, for a Data-TW-GW which connects with 3rd party cloud/infrastructure, e.g. Sending data packets to 3rd parties'infrastructure or receiving data plane packets from 3rd parties'infrastructure, etc.

Different C/M functions in different domains are connected via an external interface, as shown in FIG. 6D. A C/M function in the BAS domain A and a C/M function in the BAS domain B are connected via an external interface 6G-C/M_Function-1.

Interface 6G-C/M_Function-1 is used for:
enabling direct communication between NET4CON C/M functions in different BAS/infrastructure domains;
enabling direct communication between a BAS domain which has connection with 3rd parties'infrastructure and the control/management function of the 3rd parties;
coordinating data plane processes and data packets exchange.

It should be noted that the names for the above interfaces are simply illustrative, and should not be construed as limitations to the embodiments of the present disclosure.

The following will describe how the first network element (the C/M function) controls and manages the second network element (C/M-TW-GW) connected with the fourth network element (C/M function entity of a XaaS service) and the third network element (Data-TW-GW) connected with the fifth network element (data function entity of a XaaS service) of the BAS domain.

As mentioned above, the C/M function can realize information acquisition, for example, obtaining the XaaS service deployment profile and/or XaaS service authorization profile, such obtained profile(s) can be used for establishing a logical connection between the C/M-TW-GW and the C/M function entity of a XaaS service, as well as the logical connection between the Data-TW-GW and the data function entity of a XaaS service, and can also be used for configuring the C/M-TW-GW so as to enable the C/M-TW-GW to support an anonymous and secured connection between C/M function entities of XaaS services.

In a possible implementation, the first network element is configured to obtain a gateway deployment profile of network element(s) in the BAS domain in which the first network element is located. The network elements can be multiple second network elements or multiple third network elements as shown in FIG. 6A, and the gateway deployment profile may include deployment information (e.g., reachable addresses) of the second network elements (C/M-TW-GWs) or the third network elements (Data-TW-GWs), so that connections between the second network elements or connections between the third network elements can be configured by the first network element based on the gateway deployment profile.

In a possible implementation, the first network element is configured to obtain a gateway deployment profile of network element(s) in another BAS domain different from the BAS domain in which the first network element is located. The network elements can be eighth network element(s) (C/M-TW-GWs) or ninth network element(s) (Data-TW-GWs) in another BAS domain different from the BAS domain in which the first network element is located. Here the gateway deployment profile can include deployment information (e.g., reachable addresses) about gateways (e.g., C/M-TW-GW(s) and Data-TW-GW(s)) in another BAS domain, which is not limited herein. Upon obtaining such gateway deployment profile, the first network element can configure a logical connection between a second network element under control of the first network element and an eighth network element under control of a seventh network element (e.g., C/M function) in another BAS domain, and/or a logical connection between a third network element under control of the first network element and a ninth network element under control of the seventh network element in another BAS domain.

In a possible implementation, the first network element is configured to obtain a gateway deployment profile of network element(s) of third party/parties. Here the gateway deployment profile can include deployment information (e.g., reachable addresses) about gateways of third party/parties, which is not limited herein. Upon obtaining such gateway deployment profile, the first network element can configure a logical connection between a C/M-TW-GW under control of the first network element and a gateway of a third party, and/or a logical connection between a Data-TW-GW under control of the first network element and a gateway of a third party.

In a possible implementation, the first network element is configured to: obtain a first profile of the fourth network element; and configure the second network element based on the first profile; where the first profile includes at least one of a reachable address of the fourth network element used for establishing a connection between the fourth network element and the second network element or an authorization profile of the fourth network element, and the authorization profile of the fourth network element (also referred to as XaaS service authorization profile mentioned above) is used for determining a consumer to which the fourth network element is capable of providing a first basic service. Among then, the consumer may refer to a consumer XaaS service which requests a service (which is also referred to as first basic service or XaaS service herein) from one or more producer XaaS services, and the producer XaaS service refers to a XaaS service which provides a service requested by the consumer XaaS service through its C/M function entity (which is also referred to as fourth network element herein), and the first basic service can be any one XaaS service in FIG. 5 or any other possible XaaS service. Here, the reachable address of the fourth network element can be, e.g., a reachable physical address of the fourth network element, such as an ID of the fourth network element, it could also be in other forms, as long as the fourth network element can be reached by other network elements.

As mentioned in previous part, there are various kinds of XaaS services. When providing the service, one XaaS service may need the help from the other XaaS service, or may seek provisioning of service from another XaaS service, so the two XaaS services may play different roles, namely, one XaaS service acts as a consumer XaaS service, and the other XaaS service acts as a producer XaaS service. The consumer XaaS Service generally refers to a service which needs a service from another XaaS service, and the producer XaaS Service generally refers to a service which provides a service to the consumer XaaS service. For example, for a NET4AI service which provides AI capability to support a variety of AI applications, it may need the NET4DAM service for realizing data collection, so in this example, the NET4AI service is a consumer XaaS service and the NET4DAM service is a producer XaaS service. Among them, the producer XaaS service can be any one XaaS service in FIG. 5 or any other possible XaaS service, and the consumer XaaS service can also be any one XaaS service in FIG. 5 or any other possible XaaS service.

In an implementation of the present disclosure, the authorization profile of the fourth network element includes an identification of the first basic service and an identification of the fourth network element; the authorization profile of the fourth network element further includes at least one of following items: an identification of a consumer XaaS service provided by the consumer and an identification of a network element of the consumer XaaS service (or referred to as an identification of a provider of the second service, provider ID of the second service); or, a permissions condition for determining the consumer. Among them, the consumer XaaS service can also be any one XaaS service in FIG. 5 or any other possible XaaS service. By using the above information, the consumer to which the fourth network element is capable of providing the first basic service can be determined in a much easier way.

In an implementation of the present disclosure, the authorization profile can include a consumer list, the consumer list including one or more consumers to which the fourth network element is capable of providing the first basic service is directly transmitted to the first network element, and the first network element determines the consumer based on the consumer list. In another possible implementation, the authorization profile can include an authorization condition, the authorization condition for determining which consumer can be provided with the first basic service is transmitted to the first network element, the authorization condition may be related to traffic load of a candidate consumer, when a candidate consumer meets the authorization condition, then the first network element determines it as the consumer, it should be noted that the example is simply for illustration purpose, and the authorization condition is not limited in the embodiments of the present disclosure.

In an implementation of the present disclosure, the first network element can establish the connection between the fourth network element and the second network element based on the reachable address of the fourth network element; and configure the second network element based on such connection and the authorization profile of the fourth network element.

In an implementation of the present disclosure, the first network element is configured to receive the first profile from the fourth network element. In an implementation, the first network element receives a registration message from the fourth network element, where the registration message is indicative of the first profile. Specifically, the registration message is transmitted to the first network element by registration of the fourth network element to the first network element, and the first network element directly receives the registration message transmitted by the fourth network element, or forwarded by a further network element from the fourth network element, the further network element is connected to the fourth network element.

In an implementation of the present disclosure, the second network element is configured to receive the first profile from a sixth network element connected to the second network element and forward the first profile to the first network element; and the first network element is configured to receive the first profile from the second network element. In an implementation, the second network element is configured to receive the first profile forwarded by a further network element from a sixth network element, where the further network element is connected with the sixth network element. For example, the sixth network element is a confederation network (CONET) or the sixth network element is deployed in the CONET, which stores the reachable address of the fourth network element and the authorization profile of the fourth network element, the CONET provides a capability to enable multiple partners jointly provide 6G services. This capability is provided by confederation formation, mutual authentication, mutual authorization among partners and negotiation of agreement on recording and retracing of selected actions performed by partners, in order to assure a trustworthy environment of 6G System operations. In the above latter implementation, the further network element may be another C/M-TW-GW in the same BAS domain as the second network element, the further network element first receives the first profile from the sixth network element, and then transmits the received first profile to the first network element. It should be noted that the operation of the further network element can be the same as that of the second network element described in the embodiments of the present disclosure.

In an implementation of the present disclosure, the first network element is configured to receive the first profile from a first basic service to which the fourth network element belongs. In an implementation, the first network element receives a registration message from the first basic service, where the registration message is indicative of the first profile. Specifically, the registration message is transmitted to the first network element by registration of the first basic service to which the fourth network element belongs to the first network element.

In the case where the first profile is from the sixth network element or the first basic service, the first profile may be a XaaS service deployment profile (which is also referred to as a deployment profile of the first basic service) and/or a XaaS service authorization profile.

The XaaS service deployment profile may include information, such as, an ID of the XaaS service (which refers to an ID of the first basic service and is also referred to as XaaS service ID), an ID of a provider providing the XaaS service (which refers to an ID of a provider which provides the first basic service and has its entity(entities) in the BAS domain, and this ID is also referred to as provider ID, said provider has a C/M function entity in the BAS domain which is the above-mentioned fourth network element), an ID of a C/M function entity of the XaaS service (which refers to an ID of the fourth network element of the first basic service, and is also referred to as C/M function entity ID) in the same BAS domain as the first network element, a reachable (physical) address of the C/M function entity of the XaaS service, an ID of a data function entity of the XaaS service (which refers to an ID of a fifth network element of the first basic service, and is also referred to as data function entity ID) in the same BAS domain as the first network element, a reachable physical address of the data function entity. Therefore, the XaaS service deployment profile includes the reachable address of the fourth network element, and upon receiving the XaaS service deployment profile, the first network element can get the reachable address of the fourth network element for configuring the fourth network element.

The XaaS service authorization profile may include information, such as, an ID of the XaaS service (which refers to an ID of the first basic service and is also referred to as XaaS service ID), an ID of a provider providing the XaaS service (which refers to an ID of a provider which provides the first basic service and has its entity(entities) in the BAS domain, and this ID is also referred to as provider ID, said provider has a C/M function entity in the BAS domain which is the above-mentioned fourth network element), ID(s) of C/M function entity/entities of consumer XaaS service(s) (also referred to as authorized consumer ID(s)) to which the fourth network element is authorized to provide XaaS service in the same BAS domain as the first network element, and ID(s) of the authorized consumer XaaS services. The ID(s) of C/M function entity/entities of consumer XaaS service(s) to which the fourth network element is authorized to provide XaaS service can be taken as the authorization profile of the fourth network element, and upon receiving the XaaS service authorization profile, the first network element can get the authorization profile of the fourth network element for configuring the fourth network element.

Based on the above, the first network element can obtain the first profile of the fourth network element in various ways, so the reception of the first profile can be set flexibly according to actual requirements.

Upon obtaining the first profile of the fourth network element, the configuration of the second network element can be done based on the first profile. In an implementation of the present disclosure, in the case where the at least one second network element includes two or more second network elements, for configuring the second network element based on the first profile, the first network element may first determine said second network element (the one to be configured) from the two or more second network elements and then configure the determined second network element based on information in the first profile. That is, the first network element controls and manages the two or more second network elements, upon receiving the first profile of the fourth network element, the first network element may determine a second network element for the fourth network element. For example, the first network element may consider specific information contained in the first profile and then select/choose a suitable second network element for the fourth network element.

In an implementation of the present disclosure, when the first profile includes the reachable address of the fourth network element, the first network element can randomly select one second network element (e.g., one C/M-TW-GW) in the BAS domain, or select a C/M-TW-GW based on attributes of the C/M-TW-GWs, such as the traffic load, as the second network element. For example, the C/M function selects a C/M-TW-GW with the smallest traffic load as the second network element, it should be understood that the selection condition is simply for illustration purpose, and not limited in the embodiment of the present disclosure. In this case, information for configuring the second network element is included in the first profile, and the information for configuring the second network element is the reachable address of the fourth network element.

In an implementation of the present disclosure, when the first profile includes the authorization profile of the fourth network element, the first network element can determine a consumer to which the fourth network element is capable of providing the first basic service, then based on the authorization profile and a connection between a C/M function entity of the consumer in the BAS domain (which is the BAS domain in which the fourth network element is located) and C/M-TW-GW(s), select a C/M-TW-GW as the second network element. For example, in addition to the first network element (i.e., the C/M function) and fourth network element (i.e., the C/M function entity of the first basic service in a BAS domain), there are C/M-TW-GW1, C/M-TW-GW2, C/M-TW-GW3 and C/M-TW-GW4, C/M function entity A of consumer 1, C/M function entity B of consumer 2 in one BAS domain, the authorization profile indicates that the fourth network element can provide the first basic service to C/M function entity A of consumer 1 and C/M function entity B of consumer 2, and C/M function entity A of consumer 1 is connected to C/M-TW-GW1 but not to C/M-TW-GW2, and C/M function entity B of consumer 2 is connected to C/M-TW-GW2 but not to C/M-TW-GW1, while neither of C/M-TW-GW3 and C/M-TW-GW4 is connected to the C/M function entity A of consumer 1 and the C/M function entity B of consumer 2. Then the C/M-TW-GW1 is selected as a second network element to be configured for supporting anonymous and secured interaction between the C/M function entity A of consumer 1 and the fourth network element based on the authorization profile and the connection between C/M function entity A of consumer 1 and the C/M-TW-GW1, and the C/M-TW-GW2 is selected as a second network element to be configured for supporting anonymous and secured interaction between the C/M function entity B of consumer 2 and the fourth network element based on the authorization profile and the connection between C/M function entity B of consumer 2 and the C/M-TW-GW2. In this case, information for configuring C/M-TW-GW1 is included in the first profile, and is authorization information related to the C/M function entity A of consumer 1 in the authorization profile of the fourth network element, information for configuring C/M-TW-GW2 is included in the first profile, is authorization information related to the C/M function entity B of consumer 2 in the authorization profile of the second network element.

In an implementation of the present disclosure, the first network element configuring the second network element based on the first profile further includes, the first network element transmitting information in the first profile to the second network element; and the second network element receiving the information in the first profile from the first network element. The information in the first profile aforementioned can be used for operations of the second network element, the operations of the second network element can be for example, operations involved with the second network element during the establishment of the connection between the second network element and the fourth network element, and the configuration of the second network element. The information in the first profile can be part or all of the information in the first profile.

For example, as mentioned in the above example, if the C/M-TW-GW (second network element) is selected based on the connection between the C/M-TW-GW and the C/M function entity/entities of consumer(s), the information in the first profile transmitted to the C/M-TW-GW would be authorization information in the authorization profile related to the C/M function entity/entities of consumer(s) connected to the C/M-TW-GW.

In this way, instead of transmitting all information to the second network element, the first network element simply transmits information related to operations of the second network element (specific information) to the second network element, thus reducing the system overhead.

When the first profile merely includes the reachable address of the fourth network element, the step of the first network element configuring the second network element based on the first profile is a procedure of establishing the connection between the second network element and the fourth network element, and in this case, the fourth network element can be a C/M function entity of a consumer XaaS service or a C/M function entity of a producer XaaS service. When the first profile merely includes the authorization profile of the fourth network element, the step of the first network element configuring the second network element based on the first profile is a configuration procedure of the second network element for supporting service provision of the fourth network element. When the first profile includes both the reachable address and the authorization profile of the second network element, the step of the first network element configuring the second network element based on the first profile is connection and configuration procedures of the second network element. In the first case, the second network element is configured to establish the connection between the fourth network element and the second network element based on the first profile. The configuration of the connection between the fourth network element and the second network element is shown in FIG. 7A, and specifically includes the following step.

S701A, the first network element notifies the second network element of the reachable address of the fourth network element, or, the first network element notifies the fourth network element of a reachable address of the second network element based on the reachable address of the fourth network element. The first network element may have multiple choices when configuring the connection, each of the two parties for setting up a connection may be notified of its opposite parties'reachable address.

S702A, the second network element establishes a connection between the second network element and the fourth network element based on the reachable address of the fourth network element. If the fourth network element is notified of the reachable address of the second network element, such establishment may be initiated by the fourth network element, if the second network element is notified of the reachable address of the fourth network element, such establishment may be initiated by the second network element.

S703A, the second network element transmits a first notification to the first network element, and the first network element receives the first notification from the second network element. The first notification is indicative of the connection between the second network element and the fourth network element. In a possible implementation, the first notification may include the type of the connection, the identification of the connection, the type of the connection can be determined based on a protocol corresponding to the connection, for example, the type of the connection can be a TLS (Transport Layer security) connection, which is not limited in the embodiment of the present disclosure. The first notification may further include the identification of the second network element so as to enable the first network element to recognize the second network element, alternatively, the first notification may also skip including the identification of the second network element, in this case, the first network element may recognize the second network element from the first notification per se, e.g., from an interface through which the first notification is received. Upon receiving the first notification, the first network element can record the connection between the second network element and the fourth network element.

After the connection between the second network element and the fourth network element is established, the second network element transmits the first notification indicating such connection to the first network element, so that the first network element can better manage and control the second and fourth network elements.

S704A, after receiving the first notification, the first network element transmits a first acknowledgement to the second network element, and the second network element receives the first acknowledgement from the first network element. The first acknowledgement is indicative of a reception of the first notification.

In an implementation of the present disclosure, both of the first notification and the first acknowledgement include an identification of the first basic service. In this way, the interaction of the information between the first network element and the second network element can be performed safely and reliably.

In an implementation of the present disclosure, the first notification includes an identification of the second network element, an identification of the first basic service, an identification of the fourth network element and connection description information of the connection between the second network element and the fourth network element. Here the connection description information may include the type of the connection, the identification of the connection, etc., which is not limited in the embodiments of the present disclosure.

FIG. 7B illustrates a schematic flowchart of an exemplary connecting process between a second network element and a fourth network element according to one or more embodiments of the present disclosure. The first network element is the C/M function of NET4CON service, the second network element is a C/M-TW-GW in the service of NET4CON, and the fourth network element is C/M Function entity of a XaaS Service. The pre-condition for establishing the connection between the C/M-TW-GW and the C/M Function entity is: C/M-TW-GW(s) in each BAS domain has been deployed; XaaS service C/M function entity which should connect with a C/M-TW-GW has been deployed and configured; both C/M-TW-GW and C/M function entity of a XaaS service have obtained required certificates (for certificate based solution).

The C/M function is implemented in BAS domain/infrastructure domain. The C/M function needs to maintain a local BAS domain/infrastructure topology table. This table, for each C/M-TW-GW, keeps information on each of established logical secured connection between this C/M-TW-GW and a C/M function entity of a XaaS service. As described above, after the connection between the second network element (C/M-TW-GW) and the fourth network element (a C/M function entity of a XaaS service) is established, the first network element may be notified of such established connection, and the first network element may store the information locally, for example, in the local BAS domain/infrastructure topology table described above.

The establishment of such connection can be triggered by either the C/M-TW-GW or the C/M function entity of the XaaS service. In the first case, the C/M-TW-GW can be notified by C/M function of the NET4CON service on the reachable address of the newly deployed C/M function entity of the XaaS service, that is, the C/M function of the NET4CON service notifies the reachable address of the C/M function entity of the XaaS service to the C/M-TW-GW based on the reachable address of the C/M function entity of the XaaS service. In the latter case, the newly deployed C/M function entity of the XaaS service can be configured on reachable address of the C/M-TW-GW, for example, the C/M function notifies the reachable address of the C/M-TW-GW to the C/M function entity of the XaaS service.

As shown in FIG. 7B, the connection between the C/M-TW-GW and the C/M Function entity is established via an external interface (shown as 6G-C/M-1), and the established connection is a TLS (Transport Layer Security, TLS) connection. Here it should be noted that the TLS connection shown in the figure is simply exemplary, and there could be other types of connection in actual applications.

After establishing the connection, the C/M-TW-GW transmits message 2.1 (which is a specific example of the above first notification) to the C/M function to report the establishment of the TLS connection, where message 2.1 includes an ID of the XaaS service to which the C/M function entity belongs and an ID of the C/M function entity, then the C/M function updates a C/M plane topology table (which may be included in the BAS/administration domain logical topology mentioned above) in response to the received message 2.1, the C/M plane topology table includes an ID of a C/M-TW-GW, an ID of a C/M function entity connected to the C/M-TW-GW, an ID of an XaaS service to which the C/M function entity belongs, and a type and a parameter of the connection, such as, TLS connection, and the parameter related to the TLS connection. In response to the message 2.1 received from the C/M-TW-GW, the C/M function transmits message 2.3 (which is a specific example of the above first acknowledgement) for indicating a reception of message 2.1 to the C/M-TW-GW.

It should be noted that message 2.3 may include other information instead of the XaaS service ID for indicating the reception of message 2.1. Besides, the specific content of messages shown in tables throughout the document is only for illustration purpose, rather than limitation.

It should be understood that, in addition to the above illustrated case where the C/M-TW-GW connected to the C/M function entity and the C/M-TW-GW reporting the establishment of the connection to the C/M function are the same gateway, the solution of the present disclosure is also applicable for the case where the C/M-TW-GW connected to the C/M function entity and the C/M-TW-GW reporting the establishment of the connection to the C/M function are not the same gateway.

FIG. 7C illustrates a schematic flowchart of an exemplary configuration procedure of a second network element (i.e., C/M-TW-GW) according to one or more embodiments of the present disclosure. The first network element is the C/M function of NET4CON service, the second network element is the C/M-TW-GW in the NET4CON, the third network element is the Data-TW-GW in the NET4CON. The pre-conditions for configuring a to-be-configured-C/M-TW-GW are as follows: C/M-TW-GW(s) in each BAS domain controlled and managed by a C/M function has been deployed; secured connection between the deployed C/M-TW-GWs and between the C/M function and the C/M-TW-GWs have been established, the establishment can be implemented as shown in FIG. 7B; CONET has topology profiles of XaaS services deployment (which is also referred to as deployment profiles of XaaS services) in each of BAS domains; CONET has mutual authorization profiles of XaaS services in each of BAS domains. CONET and the to-be-configured C/M-TW-GW are in the same BAS domain in this example. It should be understood that the solution of the present disclosure is also applicable for the case where CONET and the to-be-configured C/M-TW-GW are in different BAS domains.

The purpose of the configuration procedure is to configure the to-be-configured C/M-TW-GW on the deployment profile in a BAS domain (entity level) and the authorization profile. A deployment profile of a XaaS service (or referred to as XaaS service deployment profile mentioned above) includes information, such as, XaaS service ID, provider ID, its deployed C/M plane entities IDs and their reachable physical addresses, its deployed data plane entities IDs and their reachable physical addresses and etc. An authorization profile of a XaaS service includes information, such as, XaaS service ID, provider ID, its authorized consumer IDs and IDs of XaaS services provided by these consumers.

C/M function creates an authorization table based on these profiles. The authorization table combines authorization profiles of XaaS service providers that deploy their entities in the BAS domain.

Note that an entity that triggers the configuration procedure could be any XaaS services, e.g., CONET, Mission Management and etc. In the shown procedure, CONET is used as an example.

In this procedure example, the C/M function obtains the deployment profiles and authorization profiles of XaaS services from CONET. In other cases, the deployment profiles and the authorization profiles can be transmitted to C/M function by XaaS services directly, i.e., by registration of XaaS services to C/M function. Or the deployment profiles and the authorization profiles can be obtained by registration of each deployed C/M function entity to C/M function, after the logical connection establishment.

As shown in FIG. 7C, the C/M function controls and manages a C/M-TW-GW and a Data-TW-GW in a BAS domain to which it belongs, there may be one or more C/M-TW-GWs, and CONET also belongs to this BAS domain; where the connection between one of the C/M-TW-GWs and the C/M function is established via an internal interface, and the connection between the C/M-TW-GW and CONET is established via an external interface (shown as 6G-C/M-1). The C/M-TW-GW connected to CONET can be the to-be-configured C/M-TW-GW or not.

CONET (which is a specific example of the above sixth network element) first transmits message 1 (which is a specific example of the above first profile) to the C/M-TW-GW connected to CONET for triggering this configuration procedure, where message 1 includes the deployment profiles and the authorization profiles of XaaS services. The C/M-TW-GW connected to CONET is only for transparent transmission, and does not have the right to access the received profiles. The C/M-TW-GW forwards the deployment profiles and the authorization profiles of XaaS services included in message 1 through message 2.1 (which is also a specific example of the above first profile) to the C/M function; then the C/M function stores the deployment profiles and the authorization profiles, and combines the authorization profiles to create an authorization table, the combination can be performed in any well-known manner, which is not limited in the embodiments of the present disclosure. Next, the C/M function transmits the deployment profile and the authorization profile, preferably transmits the deployment profile and the authorization profile specific to the to-be-configured C/M-TW-GW based on the stored profiles. The to-be-configured C/M-TW-GW stores the deployment profile and the authorization profile from the C/M function, and transmits message 2.5 (which is a specific example of the above first acknowledgement) to the C/M function in response to message 2.3 (which is a specific example of the above information in the first profile), message 2.5 can include any information for responding to message 2.3, as long as these two messages are corresponding and the C/M function gets acknowledge of the reception of message 2.3. After receiving message 2.5 from the C/M-TW-GW, the C/M function creates a C/M-TW-GW configuration record including C/M-TW-GW ID, XaaS service entities deployment profiles, XaaS service Authorization table.

It should be understood that, in addition to the above illustrated case where the C/M-TW-GW connected to CONET and the to-be-configured C/M-TW-GW are the same gateway, the solution of the present disclosure is also applicable for the case where the C/M-TW-GW connected to CONET and the to-be-configured C/M-TW-GW are not the same gateway.

In an implementation of the present disclosure, the second network element is configured to transmit a first load report to the first network element, where the first load report is indicative of load traffic handled by the second network element; and the first network element is configured to receive the first load report from the second network element. The first load report reflects the load status of C/M-TW-GW(s), so by letting the C/M-TW-GW report the first load report, the load status of the C/M-TW-GW can be tracked.

In an implementation of the present disclosure, the first network element is configured to set an occasion for reporting the first load report by the second network element.

For example, the C/M function can receive a load report from each of C/M-TW-GWs that it controls and manages, and each C/M-TW-GW continuously or periodically reports its load traffic automatically, or in response to an instruction from the C/M function, or based on at a certain occasion, such occasion includes but is not limited to: reporting the load traffic at certain time intervals, reporting the load traffic continuously or periodically when the load traffic is larger or smaller than a preset value. This occasion can be configured by the first network element or predefined. Since the occasion for reporting the load report can be set by the first network element or predefined, the load report can be reported flexibly according to actual applications.

In an implementation of the present disclosure, when there are more than one second network element, that is, the at least one second network element includes two or more second network elements, it becomes possible for the first network element to re-select a second network element based on the first load reports from these second network elements; where the first network element is configured to select a further second network element among the two or more second network elements based on first load reports from the two or more second network elements. In this way, the first network element (e.g., a C/M function which serves as a controller) can acquire the load report of each second network element (e.g., C/M-TW-GW) that it controls and manages, and reconfigure a new C/M-TW-GW in time when the load traffic of the previously configured C/M-TW-GW does not meet the preset threshold, thereby efficiently managing and controlling the C/M-TW-GW and saving system overhead.

For example, after receiving the load traffic of the configured C/M-TW-GW (i.e., the second network element), the C/M function determines whether the load traffic of the configured C/M-TW-GW exceeds a preset threshold, if yes, the C/M function needs to determine a further to-be-configured C/M-TW-GW based on the authorization profile of the C/M function entity. The configuration procedure of the further C/M-TW-GW (including the determination of the further second network element and the transmission of the information specific to the further second network element) is as same as that of the configured C/M-TW-GW, reference may be made to relevant description in the previous part and will not be repeated here. In an implementation, the first network element can maintain both connections, that is, the connection between the second network element and the fourth network element, and the connection between the fourth network element and the further second network element. In another implementation, after the C/M function transmits configuration information (the above information in the first profile) corresponding to the further C/M-TW-GW to the further C/M-TW-GW, the C/M function controls previously configured C/M-TW-GW to disconnect from the C/M function entity. In this way, the maintaining of the load balance can be realized by the first network element.

In a possible implementation, the first network element is configured to: obtain a second profile; and configure the third network element based on the second profile; where the second profile includes at least one of a mission profile of the third network element or a reachable address of the fifth network element, where the mission profile is used for indicating an execution of an action in a mission by the third network element, and the reachable address of the fifth network element is used for establishing a connection between the third network element and the fifth network element. In a possible implementation, the first network element can be a C/M function as mentioned above, the third network element can be a to-be-configured Data-TW-GW, the fifth network element can be a data function entity of a XaaS service in a BAS domain and may be a network element for performing an action next to the third network element when completing a mission (e.g., triggered by a MM service), and the C/M function is configured to control and manage a logical connection between the Data function entity and the to-be-configured Data-TW-GW, and further adapted to configure the to-be-configured Data-TW-GW. Here, the reachable address of the fifth network element can be, e.g., a reachable physical address of the fifth network element, such as an ID of the fifth network element, it could also be in other forms, as long as the fifth network element can be reached by other network elements. The mission profile may be from an MM service, and the third network element is a network element for completing the mission issued by the MM service, such completion may require multiple third network elements, in that case, the second profile (as will be explained later, one specific example is a mission session configuration profile) may include mission profiles of all required third network elements for completing a mission, each of the third network elements may be configured in the same way, in this case, the mission profile of each third network element is used for indicating an execution of an action in a mission by the each third network element. The mission is to achieve a designated goal, known as a mission goal, which includes providing PDU (packet data unit) connectivity and providing data processing. The mission can includes one or more actions, the actions can be, for example, AI training, AI inference, data pre-processing, data de-privatization, data cleaning, data collection, data analytics, sensing, etc.

In an implementation of the present disclosure, the second profile includes the reachable address of the fifth network element, and the first network element is configured to receive the second profile from the fifth network element. In an implementation, the first network element receives a registration message from the fifth network element, where the registration message is indicative of the reachable address of the fifth network element. Specifically, the registration message is transmitted to the first network element by registration of the fifth network element to the first network element, and the first network element directly receives the registration message transmitted by the fifth network element, or forwarded by a further network element from the fifth network element, the other network element is connected to the fifth network element.

In an implementation of the present disclosure, the second profile includes the reachable address of the fifth network element; the third network element is configured to receive the second profile from a sixth network element connected to the third network element and forward the second profile to the first network element; and the first network element is configured to receive the second profile from the third network element. For example, the sixth network element is a confederation network (CONET), which stores the reachable address of the fifth network element and the authorization profile of the fifth network element.

In an implementation of the present disclosure, the second profile includes the reachable address of the fifth network element, and the first network element is configured to receive the second profile from a first basic service to which the fifth network element belongs. In an implementation, the first network element receives a registration message from the first basic service, where the registration message is indicative of the second profile. Specifically, the registration message is transmitted to the first network element by registration of the first basic service to which the fifth network element belongs to the first network element.

Besides, the reachable address of the fifth network element can also be obtained from the XaaS service deployment profile, reference may be made to relevant description in the above part for describing the obtaining of the first profile, which will not be repeated here.

Based on the above, the first network element can obtain the second profile of the fifth network element in various ways, so the reception of the second profile can be set flexibly according to actual requirements.

Upon obtaining the second profile of the fifth network element, the configuration of the third network element can be done based on the second profile. In an implementation of the present disclosure, in the case where the at least one third network element includes two or more third network elements, for configuring the third network element based on the second profile, the first network element may first determine said third network element from the two or more third network elements and then configure the determined third network element based on information in the second profile. That is, the first network element controls and manages the two or more third network elements, upon receiving the second profile of the fifth network element, the first network element may determine a third network element. For example, the first network element may consider specific information contained in the second profile and then select/choose a suitable third network element.

In an implementation of the present disclosure, when the second profile includes the reachable address of the fifth network element, the first network element can randomly select one third network element (e.g., one Data-TW-GW) in the BAS domain, or select a Data-TW-GW based on attributes of the Data-TW-GWs, such as the traffic load, as the third network element. For example, the C/M function selects a Data-TW-GW with the smallest traffic load as the third network element, it should be understood that the selection condition is simply for illustration purpose, and not limited in the embodiment of the present disclosure.

In an implementation of the present disclosure, when the second profile includes the mission profile of the third network element, the first network element can select a Data-TW-GW based on the mission profile and a connection between a data function entity of a XaaS service (the fifth network element) in the same BAS domain as the third network element and the Data-TW-GWs, as the third network element. For example, in addition to the first and fifth network elements (i.e., the C/M function and the data function entity of a XaaS service in a BAS domain), there are multiple third network elements (gateways, i.e., Data-TW-GW1, Data-TW-GW2), the mission profile indicates an execution of action in a mission by a gateway, for example, through an action to be executed by a gateway, an identification of a next network element (the fifth network element) for performing another action after the third network element, and an identification for indicating the second action, then since the fifth network element is connected to Data-TW-GW1 but not to Data-TW-GW2, so the first network element may choose the Data-TW-GW1 as the third network element based on the mission profile and the connection between a data function entity of a XaaS service and the Data-TW-GW1.

In an implementation of the present disclosure, the first network element can establish the connection between the third network element and the fifth network element based on the reachable address of the fifth network element; and configure the third network element based on such connection and the mission profile of the third network element.

In an implementation of the present disclosure, the first network element configuring the third network element based on the second profile further includes, the first network element transmitting information in the second profile to the third network element; and the third network element receiving the information in the second profile from the first network element. The information in the second profile aforementioned can be used for operations of the third network element, the operations of the third network element can be for example, operations involved with the third network element during the establishment of the connection between the third network element and the fifth network element, and the configuration of the third network element. The information in the second profile can be part or all of the information in the second profile.

In an implementation of the present disclosure, the information in the second profile includes an identification for indicating a first action to be performed by the third network element, a QoS (Quality of Service) parameter of the third network element, an identification for indicating a next network element for performing a second action after the third network element, and an identification for indicating a connection between the third network element and the next network element (e.g., the fifth network element). For example, the first action may be decryption or encryption operation when transferring a data packet from a data function entity of a XaaS service to a data function entity of another XaaS service (the fifth network element), and the second action may be an action for providing a corresponding service by the fifth network element, e.g., data collection in the case of NET4DAM service. For another example, the first action may be an operation of transforming a data format of a data packet when transferring the data packet from a data function entity of a XaaS service to a data function entity of another XaaS service (the fifth network element), so that the data packet from the data function entity of the XaaS service can be parsed or understood by the data function entity of another XaaS service.

In an implementation of the present disclosure, the information in the second profile includes an identification for indicating a QoS (Quality of Service) parameter of the third network element.

For example, the third network element is configured to process protocol processing for QoS and route based on configuration by mission management or be carried in protocol stacks. For example, in the later case, the Data-TW-GW processes the protocol headers and performs corresponding QoS handling and routing operation.

When the second profile merely includes the reachable address of the fifth network element, the step of the first network element configuring the third network element based on the second profile is a procedure of establishing the connection between the third network element and the fifth network element, and in this case, the fourth network element can be a data function entity of a consumer XaaS service or a data function entity of a producer XaaS service. When the second profile merely includes the mission profile of the third network element, the step of the first network element configuring the third network element based on the second profile is a configuration procedure of the third network element. When the second profile includes both the reachable address of the fifth network element and the mission profile of the third network element, the step of the first network element configuring the third network element based on the second profile is connection and configuration procedures of the third network element. In the first case, the third network element is configured to establish the connection between the third network element and the fifth network element based on the second profile. The configuration of the connection between the third network element and the fifth network element is shown in FIG. 8A, and specifically includes the following step.

S801A, the first network element notifies the third network element of the reachable address of the fifth network element, or the first network element notifies the fifth network element of a reachable address of the third network element based on the reachable address of the fifth network element.

S802A, the third network element establishes a connection between the third network element and the fifth network element based on the reachable address of the fifth network element.

S803A, the third network element transmits a second notification to the first network element, and the first network element receives the second notification from the third network element. The second notification is indicative of the connection between the third network element and the fifth network element.

Steps S801A-803A are similar to steps S701A-703A above, the detailed description of steps S801A-803A will not repeated here.

After the connection between the third network element and the fifth network element is established, the third network element transmits the second notification indicating such connection to the first network element, so that the first network element can better manage and control the third and fifth network elements.

S804A, after receiving the second notification, the first network element transmits a second acknowledgement to the third network element, and the third network element receives the second acknowledgement from the first network element. The second acknowledgement is indicative of a reception of the second notification.

In an implementation of the present disclosure, both of the second notification and the second acknowledgement includes an identification of a first basic service to which the fifth network element belongs. In this way, the interaction of the information between the first network element and the third network element can be performed safely and reliably.

In an implementation of the present disclosure, the second notification includes an identification of the third network element, an identification of a first basic service to which the fifth network element belongs, an identification of the fifth network element and of the connection between the third network element and the fifth network element. Here the connection description information may include the type of the connection, the identification of the connection, etc., which is not limited in the embodiments of the present disclosure.

FIG. 8B illustrates a schematic flowchart of an exemplary connecting process between a third network element and a fifth network element according to one or more embodiments of the present disclosure. The third network element is a Data-TW-GW of a XaaS Service, and the fifth network element is a data function entity of a XaaS Service. The pre-condition for establishing the connection is: Data-TW-GW(s) in each BAS domain has been deployed; XaaS service Data function entity which should connect with the Data-TW-GW has been deployed; both Data-TW-GW and data function entity of a XaaS service have obtained required certificates (for certificate based solution).

The C/M function is implemented in a BAS domain/infrastructure domain. The C/M function needs to maintain a local BAS domain/infrastructure topology table. This table, for each Data-TW-GW, keeps information on each of established logical secured connection between this Data-TW-GW and a data function entity of a XaaS service. As described above, after the connection between the Data-TW-GW and a data function entity of a XaaS service is established, the first network element may be notified of such established connection, and the first network element may store the information locally, for example, in the local BAS domain/infrastructure topology table described above.

The establishment of such connection can be triggered by either the Data-TW-GW or the data function entity of the XaaS service. In the first case, the Data-TW-GW can be notified by C/M function on the reachable address of the newly deployed data function entity, that is, the C/M function notifies the reachable address of the data function entity to the Data-TW-GW based on the reachable address of the data function entity. In the latter case, the newly deployed data function entity can be configured on reachable address of the Data-TW-GW, for example, the C/M function notifies the reachable address of the Data-TW-GW to the data function entity.

As shown in FIG. 8B, the connection between the Data-TW-GW and the data function entity is established via an external interface (shown as 6G-C/M-1), and the established connection is a TLS (Transport Layer Security) connection. Here it should be noted that the TLS connection shown in the figure is simply exemplary, and there could be other types of connection in actual applications.

After establishing the connection, the Data-TW-GW transmits message 2.1 (which is a specific example of the above second notification) to the C/M function to report the establishment of the TLS connection, where message 2.1 includes an ID of the XaaS service to which the data function entity belongs and an ID of the data function entity, then the C/M function updates a data plane topology table (which may be included in the BAS/administration domain logical topology mentioned above) in response to the received message 2.1, the data plane topology table includes an ID of a Data-TW-GW, an ID of a data function entity connected to the Data-TW-GW, an ID of a XaaS service to which the data function entity belongs, and a type and a parameter of the connection, such as, TLS connection, and the parameter related to the TLS connection. In response to the message 2.1 received from the Data-TW-GW, the C/M function transmits message 2.3 (which is a specific example of the above second acknowledgement) for indicating a reception of message 2.1 to the Data-TW-GW.

It should be noted that message 2.3 may include other information instead of the XaaS service ID for indicating the reception of message 2.1.

It should be understood that the solution of the present disclosure is also applicable for the case where the Data-TW-GW connected to the data function entity and the Data-TW-GW reporting the establishment of the connection to the C/M function are not the same gateway, although the case where the Data-TW-GW connected to the data function entity and the Data-TW-GW reporting the establishment of the connection to the C/M function are the same gateway is illustrated in the description.

FIG. 8C illustrates a schematic flowchart of an exemplary configuration procedure of a third network element (i.e., Data-TW-GW) according to one or more embodiments of the present disclosure.

The pre-condition for configuring a to-be-configured-Data-TW-GW is: Data-TW-GW(s) in a BAS domain has been deployed. This procedure is conducted whenever a mission service is provided.

As shown in FIG. 8C, the C/M function controls and manages a C/M-TW-GW and a Data-TW-GW in a BAS domain to which it belongs, there may be one or more Data-TW-GWs, where the connection between one of the Data-TW-GWs or C/M-TW-GWs and the C/M function is established via an internal interface, the entity that triggers the configuration procedure can be any type of trigger, such as, an entity of Mission Management (MM), and the connection between the C/M-TW-GW and the trigger entity is established via an external interface (shown as 6G-C/M-1).

The trigger entity creates a mission session configuration profile (a specific example of the second profile mentioned above) related to network elements in the BAS domain that the C/M function is located in. The trigger entity first transmits message 1 to the C/M-TW-GW connected to the trigger entity for triggering this configuration procedure, where message 1 includes the mission session configuration profile related to network elements in the BAS domain. The C/M-TW-GW connected to the trigger entity is only for transparent transmission, and does not have the right to access the received profile.

The C/M-TW-GW forwards the mission session configuration profile included in message 1 through message 2.1 to the C/M function; then the C/M function stores the mission session configuration profile, determines Data-TW-GWs that involve the mission operation, and creates mission session table for each of the determined Data-TW-GWs. Next, the C/M function transmits each mission session table (which is a specific example of the mission profile for the third network element) to a corresponding Data-TW-GW using message 2.3, the Data-TW-GW receives its own mission session table and stores it, then transmits message 2.5 to the C/M function to respond message 2.3, message 2.5 can include any information for responding to message 2.3, as long as these two messages are corresponding and the C/M function gets acknowledge of the reception of message 2.3, such as an ID of the mission session. After receiving message 2.5 from the Data-TW-GW, the C/M function creates a Data-TW-GW configuration record including the ID of the mission session and mission session table for each supporting Data-TW-GW, and transmits message 2.7 including the ID of the mission session to the C/M-TW-GW in response to message 2.1. After receiving message 2.7 from the C/M function, the C/M-TW-GW transmits message 3 including the ID of the mission session to the trigger entity in response to message 1.

It should be understood that the solution of the present disclosure is also applicable for the case where the C/M-TW-GW connected to the trigger entity and the C/M-TW-GW connected to the C/M function are not the same gateway, although the case where the C/M-TW-GW connected to the trigger entity and the C/M-TW-GW connected to the C/M function are the same gateway is illustrated in the description.

In an implementation of the present disclosure, the third network element is configured to transmit a second load report to the first network element, where the second load report is indicative of load traffic handled by the third network element; and the first network element is configured to receive the second load report from the third network element. The second load report reflects the load status of Data-TW-GW(s), so by letting the Data-TW-GW report the first load report, the load status of the Data-TW-GW can be tracked.

In an implementation of the present disclosure, the first network element is configured to set an occasion for reporting the second load report by the third network element.

For example, the C/M function can receive a load report from each of Data-TW-GWs that it controls and manages, and each Data-TW-GW continuously or periodically reports its load traffic automatically, or in response to an instruction from the C/M function, or based on at a certain occasion, such occasion includes but is not limited to: reporting the load traffic at certain time intervals, reporting the load traffic continuously or periodically when the load traffic is larger or smaller than a preset value. This occasion can be configured by the first network element or predefined. Since the occasion for reporting the load report can be set by the first network element or predefined, the load report can be reported flexibly according to actual applications.

In an implementation of the present disclosure, when there are more than one third network element, that is, the at least one third network element includes two or more third network elements, it becomes possible for the first network element to re-select a third network element based on the second load reports from these third network elements; where the first network element is configured to select a further third network element among the two or more third network elements based on second load reports from the two or more third network elements. In this way, the first network element (e.g., a C/M function which serves as a controller) can acquire the load report of each third network element (e.g., Data-TW-GW) that it controls and manages, and reconfigure a new Data-TW-GW in time when the load traffic of the previously configured Data-TW-GW does not meet the preset threshold, thereby efficiently managing and controlling the Data-TW-GW and saving system overhead. Reference may be made to relevant part above for re-selecting the second network element for detailed description.

In an implementation of the present disclosure, the first network element is configured to: instruct the second network element to log interactions between the second network element and the fourth network element; and the second network element is configured to log the interactions between the second network element and the fourth network element, and report a log result to the first network element. For example, in the case of establishing the connection between the C/M-TW-GW (i.e., second network element) and the C/M function entity of a XaaS service (i.e., fourth network element), the C/M-TW-GW logs following information related to this connection as the log result, such as at least one of the following, an ID of the C/M-TW-GW, an ID of the C/M function entity connected to the C/M-TW-GW, an ID of the XaaS service to which the C/M function entity belongs, and a type and a parameter of the connection (e.g. TLS connection); then the C/M-TW-GW reports the above information to the C/M function (i.e., first network element). In the case of configuring the C/M-TW-GW, the C/M-TW-GW logs following information related to this configuration as the log result, such as at least one of the following, the deployment profile and the authorization profile of a XaaS service and an ID of the C/M-TW-GW indicating that this C/M-TW-GW is selected as the serving C/M-TW-GW selected for the C/M function entity of the XaaS service (i.e., fourth network element); then the C/M-TW-GW reports the above information to the C/M function (i.e., first network element).

For example, the second network element is configured to monitor the signaling exchanging on the established connection between the second network element and the fourth network element, and also log the signaling exchanging, e.g., at which time, with whom the signaling exchanging happened, and how long the signaling exchanging lasts (by recording the starting time and the ending time). Such monitoring is done on the premise of compliance with common laws and regulations.

In an implementation of the present disclosure, the second network element is configured to record the load handled per se and generate a first load report for reporting to the first network element. For the details with respect to the first load report, reference can be made to the above description.

In an implementation of the present disclosure, the first network element is configured to: instruct the third network element to log interactions between the third network element and the fifth network element; and the third network element is configured to log the interactions between the third network element and the fifth network element, and report a log result to the first network element. For example, in the case of establishing the connection between the Data-TW-GW (i.e., third network element) and the data function entity of a XaaS service (i.e., fifth network element), the Data-TW-GW logs following information related to this connection as the log result, such as at least one of the following, an ID of the Data-TW-GW, an ID of the data function entity connected to the Data-TW-GW, an ID of the XaaS service to which the data function entity belongs, and a type and a parameter of the connection (e.g. TLS connection); then the Data-TW-GW reports the above information to the C/M function (i.e., first network element). In the case of configuring the Data-TW-GW, the Data-TW-GW logs following information related to this configuration as the log result, such as at least one of the following, the mission profile of the data function entity and an ID of the Data-TW-GW indicating that this Data-TW-GW is selected as the serving Data-TW-GW selected for the data function entity; then the Data-TW-GW reports the above information to the C/M function (i.e., first network element).

For example, the third network element is configured to monitor the data exchanging on the established connection between the third network element and the fifth network element, and also log the data exchanging, e.g., at which time, with whom the data exchanging happened, and how long the data exchanging lasts (by recording the starting time and the ending time). Such monitoring is done on the premise of compliance with common laws and regulations.

In an implementation of the present disclosure, the third network element is configured to record the load handled per se and generate a second load report for reporting to the first network element. For the details with respect to the second load report, reference can be made to the above description.

The following will describe the operation of a C/M-TW-GW (second network element mentioned above) for an interaction between a C/M function entity of a consumer XaaS service and a C/M function entity of a producer XaaS service in the BAS domain in which the C/M-TW-GW is located. The pre-conditions for operation of the C/M-TW-GW are as follows: a logical connection between the C/M-TW-GW and a C/M function entity of a consumer XaaS Service in the BAS domain and a logical connection between the C/M-TW-GW and a C/M function entity of a producer XaaS Service in a BAS domain have been established. For example, the above logical connections can be established with reference to relevant description for FIGS. 7A-7B and FIGS. 8A-8B.

It should be noted that there may be one or multiple C/M function entities (producer network elements below) providing a producer XaaS service (the first basic service) in a BAS domain, that is, the producer XaaS service may have multiple C/M function entities in the BAS domain, the one or multiple C/M function entities belong to the producer XaaS service.

In an implementation of the present disclosure, the second network element is configured to: receive a first request message from the fourth network element, where the first request message is indicative of a work requested by the fourth network element; and determine, based on the first request message, a procedure for implementing the work requested by the fourth network element.

The “work” here may be construed as an execution of an action or a series of actions, the action(s) can be executed by network element(s) (producer network element(s) below) whose accessibility is(are) under control of the second network element, each of the network element(s) is capable of providing a basic service, the execution of the action is an implementation of the provisioning of the basic service by the network element. In this way, by requesting the work from the second network element, the action(s) can be executed and the service provisioning of the fourth network element can thus be realized based on a result of the execution of the action(s). For example, when providing services, the fourth network element may need service(s) from other network element(s) whose accessibility is(are) under control of the second network element, the provisioning of the service(s) from other network element(s) may be implemented as an action or a series of actions executed by other network element(s), so the fourth network element may communicate with the second network element to request the execution of the action(s), then the second network element may respond to such request by determining a procedure for implementing the work (executing the action(s)), thereby facilitating the service provisioning of the fourth network element.

In a possible implementation, the second network element can be a C/M-TW-GW as mentioned above, and the fourth network element can be a C/M function entity of a consumer XaaS service and connected to the second network element, where the consumer XaaS service refers to a XaaS service which requests a service from one or more producer XaaS services, and the producer XaaS service refers to a XaaS service which provides a service requested by the consumer XaaS service through its C/M function entity (which is also referred to as producer network element herein). In the implementation, the C/M function entity of the consumer XaaS service transmits the first request message to the C/M-TW-GW to request the work, and the C/M-TW-GW is configured to ensure a trustworthy connection between the C/M function entity of the consumer XaaS service and the C/M function entity of the producer XaaS service. For example, when the NET4AI service needs the NET4DAM service for realizing data collection, the NET4AI service is a consumer XaaS service, the NET4DAM service is a producer XaaS service, the data collection is the action executed by the C/M function entity of the NET4DAM service for providing the NET4DAM service.

In a possible implementation, the second network element can be a C/M-TW-GW as mentioned above, and the fourth network element can be a vertical in the same BAS domain as the second network element and connected to the second network element, where the vertical may request a service from one or more other verticals (which will be also referred to as producer network element(s) herein). In the implementation, a vertical transmits the first request message to the C/M-TW-GW to request the work, and the C/M-TW-GW is configured to ensure a trustworthy connection between the vertical (the requester) and another vertical (the responder).

In a possible implementation, the first request message may be various kinds of requests that can indicate the procedure for implementing the work. In order to implement the work, the second network element may determine the action(s) to be taken for implementing the work, the action(s) may be executed (performed) by one or more producer network elements authorized to provide service to the fourth network element, so the second network element may determine, for each action, the producer network element to perform such action, as well as the sequence of the producer network elements in a case where multiple producer network elements are required to execute the actions dependently, the producer network element may be a C/M function entity of a producer XaaS service and connected to the second network element. Therefore, the determination of the procedure for implementing the work requested by the fourth network element may include the determination of the action(s) to be taken for implementing the work and the producer network element(s) to perform the action(s), as well as the sequence of the action(s) if necessary.

In a possible implementation, the first request message is a first type of message and simply includes partial information needed for determining the procedure for implementing the work, the second network element may determine the procedure for implementing the work based on the first request message as well as other information locally stored in the second network element.

For example, the first request message may simply include a working identification (ID for short) which indicates the mode of the procedure, and the second network element locally saves information about a correspondence between a mode of the procedure and the corresponding action(s) to be taken (as well as the sequence of the action(s) if necessary) and corresponding producer network element(s) for executing the action(s), so the second network element may determine the action(s) to be taken for implementing the work (as well as the sequence of the action(s) if necessary) and the producer network element(s) for executing the action(s) based on the mode indicated in the first request message and the locally saved information. Here the mode of the procedure may indicate how the procedure is to be executed, it also corresponds to the operation mode of the second network element when executing the procedure. In addition, the work ID may also be implemented as a message ID, so the first request message could include a message ID which is for identifying the mode of the procedure.

For another example, the first request message may indicate the mode of the procedure and the action(s) to be taken for implementing the work (as well as the sequence of the action(s) if necessary), in this case, the second network element locally saves information about a correspondence between the action(s) (as well as the sequence of the action(s) if necessary) to be taken and the producer network element(s) for executing the action(s), as a possible implementation, the second network element may determine the producer network element(s) based on the action(s) indicated in the first request message and the locally saved information. As another possible implementation, for each of the action(s), there may be multiple producer network elements as candidate producer network elements, the second network element may determine the candidate producer network elements based on the action(s) indicated in the first request message and the locally saved information, Further, the second network element locally saves information about connection(s) between the fourth network element and the producer network element(s), so the second network element may determine the producer network element(s) for executing the action(s) from the candidate producer network element(s) and the connection(s) between the fourth network element and the producer network element(s), e.g., choose producer network element(s) connected to the fourth network element.

For another example, the first request message may indicate the mode of the procedure and at least one basic service (basic service(s)) requested by the fourth network element, in this case, the second network element locally saves information about a correspondence between a mode of the procedure and the corresponding action(s) to be taken(as well as the sequence of the action(s) if necessary), so the second network element may determine the action(s) to be taken for implementing the work (as well as the sequence of the action(s) if necessary) based on the mode indicated in the first request message and the locally saved information. Further, as mentioned above, the basic service is the producer XaaS service, when the fourth network element requests a work from the second network element, it actually requests action(s) to be taken by producer network element(s) (C/M function entity(entities) of the producer XaaS service(s) authorized to provide the basic service(s) to the fourth network element), and execution of the action(s) realizes provisioning of basic service(s) by producer XaaS service(s), so when the at least one basic service is indicated in the first request message, the fourth network element indicates its required service(s), since the second network element also locally saves information about a correspondence between the fourth network element (C/M function entity of a consumer XaaS service) and the producer network element(s) (C/M function entity/entities of producer XaaS service(s)), the second network element may determine the producer network element(s) for providing the basic service(s) by executing the action(s) based on the at least one basic service requested by the fourth network element and the locally saved information. For example, in the first mode, the action to be taken for implementing the work requested by the fourth network element includes data collection, data de-privacy or data analysis which is provided by the DAM service, the DAM service is the first basic service requested by the fourth network element. In the second mode or the third mode, the actions to be taken for implementing the work requested by the fourth network element include data collection, data de-privacy and data analysis which are provided by the DAM service, and the actions also include the computing which is provided by the NET4AI, etc. the DAM service and the NET4AI are both the first basic services requested by the fourth network element.

For another example, in addition to a working identification which indicates the mode of the procedure and at least one basic service requested by the fourth network element, the first request message also includes information about the action(s) to be taken (as well as the sequence of the action(s) if necessary) so as to implement the work, and the second network element also locally saves information about a correspondence between the fourth network element (C/M function entity of consumer XaaS service) and the producer network element(s) (C/M function entities of producer XaaS services), so the second network element may determine the producer network element(s) to execute the action(s) based on the first request message and the locally saved information. In possible implementations, the producer network element(s) can be determined based on a correspondence between the action(s) to be taken (as well as the sequence of the action(s) if necessary) and the producer network element(s), or based on a correspondence between the at least one first basic service requested by the fourth network element and the producer network element(s).

In another possible implementation, the first request message is a second type of message and includes all information needed for determining the procedure for implementing the work, the second network element may then determine the procedure for implementing the work simply based on the first request message. For example, in addition to a working identification which indicates the mode of the second network element, the first request message also includes the action(s) to be taken for implementing the work and information of the producer network element(s) (e.g., ID of the producer network element or other information for identifying the producer network element) to execute the action(s) (as well as the sequence of the action(s) if necessary), in this way, the second network element may determine the action(s) to be taken for implementing the work and the producer network element(s) to execute the action(s) (as well as the sequence of the action(s) if necessary) based on the first request message. The main difference between the first type of message and the second type of message lies in that the first type of message is not intelligent, so the second network element should use local information to determine the procedure for implementing the work, but the second type of message is intelligent, so the second network element can rely only on the first request message to determine the procedure for implementing the work.

Therefore, there is a balance between the content of the first request message and the functionality of the second network element, the more information contained in the first request message, the less local information would be required to determine the procedure for implementing the work by the second network element.

In a possible implementation, the procedure for implementing the work has three modes, a first mode, a second mode or a third mode; where when the procedure is the first mode, one action is taken for implementing the work; where when the procedure is the second mode, multiple independent actions are taken for implementing the work; where when the procedure is the third mode, multiple conditional actions are taken for implementing the work.

Since the procedure has three modes, the second network element can perform different operations in different modes, thereby effectively managing the interaction between the second network element and the fourth network element.

In the first mode, there is simply one producer network element which is involved in responding to the first request message from the fourth network element, and the first request message from the fourth network element simply requests one action (a single action) by the one producer network element to implement the work requested by the fourth network element.

In the second mode and the third mode, in one implementation, there are one or more producer network elements which are involved in responding to the first request message from the fourth network element. In the second mode, the first request message from the fourth network element requests multiple actions by the one or more producer network elements to implement the work requested by the fourth network element, and the multiple actions are independent actions, so each action can be performed a corresponding producer network element independently. In the third mode, the first request message from the fourth network element requests multiple actions by the one or more producer network elements to implement the work requested by the fourth network element, and the multiple actions are dependent actions, so an action to be performed by a producer network element is dependent on a result of execution of an another action. In this implementation, each producer network element can perform one or more actions of the multiple actions.

FIGS. 9A-9C exemplary illustrate three operation modes of the second network element respectively, i.e., three modes of the C/M-TW-GW, where the C/M function entity of the consumer XaaS service and the C/M function entity of the producer XaaS service are both connected to the C/M-TW-GW, e.g., via the external interface (for example, 6G-C/M-1 shown in the figures).

### Mode 1—Single Action

In this mode, the C/M-TW-GW receives a message (a specific example for the aforementioned first request message) from one C/M function entity of one consumer XaaS service. The message requests a single action. This message is forwarded to a selected producer XaaS service after a certain process at the C/M-TW-GW. After an action at a C/M function entity of the producer XaaS service, a response type of message with result is sent back to the C/M-TW-GW. After certain process, the C/M-TW-GW sends a response message to the C/M function entity of the consumer XaaS service.

### Mode 2—Multiple Independent Actions (Parallel)

In this mode, the C/M-TW-GW receives a message (a specific example for the aforementioned first request message) from one C/M function entity of one consumer XaaS service. The message requests multiple parallel actions from other producer XaaS services. This message is forwarded to multiple selected producer XaaS services after a certain process at the C/M-TW-GW. After multiple parallel single actions at C/M function entities of the producer XaaS services, multiple response type of messages respectively from the multiple C/M function entities of the producer XaaS services with results are sent back to the C/M-TW-GW. After all actions are completed, the C/M-TW-GW sends a single response message to the C/M function entity of the consumer XaaS service, after certain process.

### Mode 3—Multiple Dependent Actions (Conditional Sequential)

In this mode, the C/M-TW-GW receives a message (a specific example for the aforementioned first request message) from one C/M function entity of one consumer XaaS service. The message requests a multiple sequential (dependent) actions from other producer XaaS services. After a certain process at C/M-TW-GW, the C/M-TW-GW performs single action procedure (mode 1) one by one based on message types and message content. After all actions are completed, the C/M-TW-GW sends a single response message to the consumer XaaS service.

In a possible implementation of the present disclosure, the third network element is configured to process a data format of a data packet when transferring the data packet. For example, the third network element is configured to receive a data packet from a network element (e.g., data function entity), and check if a data format of the data packet is in consistency with a data format of another network element (e.g., data function entity) to which the data packet goes, if not, the third network element is configured to change the data format of the data packet into the data format of another data function entity, and then pass the data packet to another data function entity. For example, the data processing result from one data function entity of a XaaS service is included in a data packet, and then the data packet is sent from the data function entity of the XaaS service to the third network element, then before forwarding the data packet to a data function entity of a next XaaS service for completing a mission, the third network element can perform data format translation (in case that the data formats of the two data function entities are different) and send the translated data packet to the data function entity of the next XaaS service, so as to ensure that the data function entity of the next XaaS service can understand or parse the data packet.

In a possible implementation of the present disclosure, the third network element is configured to perform at least one of decryption or encryption operation when transferring a data packet. For example, upon receiving a data packet, the third network element can first decrypt a data packet and then encrypt the data packet when transferring the data packet, in this way, the security of the data packet transferring is thus ensured.

In a possible implementation of the present disclosure, the first network element is communicatively connected to a seventh network element and configured to coordinate processes and data packets exchange on the data plane with the seventh network element. For example, the seventh network element can be a C/M function in another BAS domain, and the C/M functions in different BAS domains can directly communicate with each other via an interface between them. The process here may include the exchange of topography information in their own BAS domains, so that the load balancing over the whole system can be realized.

In a possible implementation of the present disclosure, the first network element is configured to: obtain a third profile, where the third profile includes reachable addresses of an eighth network element and a ninth network element under control of the seventh network element, and the reachable address of the eighth network element is used for establishing a connection between the second network element and the eighth network element, and the reachable address of the ninth network element is used for establishing a connection between the third network element and the ninth network element; configure the second network element and the eighth network element to establish the connection between the second network element and the eighth network element; and configure the third network element and the ninth network element to establish the connection between the third network element and the ninth network element. The eighth network element and the ninth network element can respectively be a C/M-TW-GW and a Data-TW-GW in a BAS domain (where the seventh network element is located) different from the BAS domain in which the second network element and the third network element are located, and Different C/M-TW-GWs in different domains can be connected according to their reachable addresses, different Data-TW-GWs in different domains can also be connected according to their reachable addresses.

The following will describe management of a C/M session and a data session for a device and D-User (Digital User which can be, e.g., in NET4DW) by the C/M function in detail. Here the C/M session can be a secured logical connection established between the 6G device/D-User and its serving C/M-TW-GW and is used for signaling exchanging therebetween on the C/M plane, and the serving C/M-TW-GW is an endpoint on the network side for the C/M session of the device. The data session may be a secured logical connection established between the 6G device/D-User and its serving Data-TW-GW and is used for data exchanging therebetween on the data plane, and the serving Data-TW-GW is an endpoint on the network side for the data session of the device. The device can be a wireless device that is able to connect to a 6G System and use authorized 6G services and 5G services. The pre-conditions for establishing the C/M session is that BAS domain logical topology has been established and the C/M Radio Bearer (RB) of the device for which the C/M session is established has been set up. The pre-conditions for establishing the data session is that BAS domain logical topology has been established; Data RB and C/M RB of the device have been set up. The C/M RB refers to over-the-air connection for carrying control signaling for over-the-air interface management and C/M plane messages. The device can have multiple C/M RBs. The Data RB of the device refers to over-the-air connection for carrying Data plane traffic. The device can have multiple Data RBs.

The D-User is a representative of a physical user who uses the first device, so the digital user can then handle events on behalf of the physical user, such intelligent setting would reduce the handling pressure of the physical user. For example, when there is an incoming call, an anchor of the D-user can check if this incoming call is desirable or not, e.g., by communicating with the operator, then if such incoming call is not desirable (e.g., crank calls), then the anchor may directly reject the incoming call, the whole process is imperceptible to the physical user, the physical user no longer needs to operate the first device, thus improving the user experience. For another example, the digital function can also be trained in advance so that it could deal with most transactions of the physical user, so the physical user can decide the extent to which the digital user replaces the physical user to handle events and train the anchor accordingly, more flexibility is thus given to user in configuring the anchor. The establishment of a C/M session for the D-User (anchor) can be similar to that of the first device, and the establishment of a data session for the D-User (anchor) can also be similar to that of the first device, except that C/M session and data session for the D-User both do not involve any process related to the setting up of the C/M RB and all the notifications/requests/responses/acknowledgements (if any) involved in the process of the establishment of the first session may be used in the same way for establishing the third session but be skipped of including indication of the first bearer.

In order to make sure that the digital function can work normally, sessions similar to the above first session and second session are necessary. In a possible implementation of the present disclosure, one or more third sessions are established between the digital function associated with the first device and a serving C/M-TW-GW for the digital function associated with the first device and each of the one or more third sessions is used for signaling exchanging between the digital function and the serving C/M-TW-GW for the digital function associated with the first device on the control and management plane; and one or more fourth sessions are established between the digital function associated with the first device and a serving Data-TW-GW for the digital function associated with the first device and each of the one or more fourth sessions is used for data exchanging between the digital function and the serving Data-TW-GW for the digital function associated with the first device on the data plane.

In a possible implementation of the present disclosure, the first network element is configured to: receive a first session establishment request, where the first session establishment request is indicative of a first device for which a first session is to be established; and configure the second network element based on the first session establishment request to establish the first session between the first device and the second network element. The first device can be the wireless device mentioned above, the first session can be the C/M session for the first device mentioned above, and the second network element can be the serving C/M-TW-GW of the first device. The first session establishment request can be seen as a trigger of the establishment of the first session, and upon receiving the first session establishment request, the first network element can start the configuration of the second network element. Depending on different content of the first session establishment request, the configuration procedure would be different.

In a possible implementation of the present disclosure, the first session establishment request includes an identification of the first device, for example, an ID of the first device, which is not limited in the embodiments of the present disclosure.

In a possible implementation of the present disclosure, the first network element is configured to receive the first session establishment request from a first service, the first service can be a CM (Connectivity Management) service, which leverages 5G connectivity management functions, but with extension to include digital world; and the first network element is further configured to transmit a first session establishment response to the first service in response to the first session establishment request, where the first session establishment response is indicative of the first device, for example, the first session establishment response can also include an ID of the first device, which is not limited in the embodiments of the present disclosure.

In a possible implementation of the present disclosure, the first session establishment request is indicative of a first bearer corresponding to the first session and a tenth network element, where a first mapping between the first bearer and the first session for the first device is maintained by the tenth network element, and the first bearer is established between the first device and the tenth network element. In the case where the first network element receives the first session establishment request from the first service, that is, when the establishment of the first session of the first device is triggered by the first service (e.g., CM service), the first service needs to establish a connection between the first device and the tenth network element through the first bearer before triggering the establishment of the first session, the first bearer can be a C/M RB of the first device, the tenth network element can be a RB handler, which is over-the-air interface protocol stack handler. A RB handler is defined as a logical function which performs RB protocol stack operations after getting configurations. The protocol stack handler is a PDCP-only handler or a whole protocol stack handler. The RB handler accepts RB configuration from Connectivity Management (CM) service. The RB handler also accepts security configuration, e.g., keying material, from Service Provisioning Management (SPM) service. The first service knows the first bearer and the tenth network element before triggering the establishment of the first session, thus can inform the first network element of the first bearer and the tenth network element through the first session establishment request. In a possible implementation, the first session establishment request can include an ID of the first bearer and an ID of the tenth network element.

In a possible implementation of the present disclosure, the first network element is configured to receive the first session establishment request from the first device or a further network element; and the first network element is further configured to transmit a second session establishment response to the first device or the further network element in response to the first session establishment request, where the second session establishment response is indicative of the first device, for example, the second session establishment response includes an ID of the first device, which is also not limited in the embodiments of the present disclosure.

The further network element can be a device other than the first device for which the first session is established, that is, the establishment of the first session can also be triggered by a different device, and such device is not aware of the first bearer and the tenth network element, so when the establishment of the first session is triggered by such device, similar to the case where the establishment of the first session is triggered by the first device, it is also necessary to interact with the first service (CM service) to get acknowledge of the first bearer and the tenth network element.

In a possible implementation of the present disclosure, first network element is further configured to: transmit a first bearer request for requesting a first bearer corresponding to the first session and a tenth network element to a first service, where the first bearer request is indicative of the first device; and receive a first bearer response from the first service, where the first bearer response is indicative of the first bearer corresponding to the first session and the tenth network element, where a first mapping between the first bearer and the first session for the first device is maintained by the tenth network element, and the first bearer is established between the first device and the tenth network element. In a possible implementation, the indication of the first device is sufficient to tell the first service that the first network element wants to know the first bearer and the tenth network element. In another possible implementation, the first bearer request can also carry other information indicating that the first network element wants to know the first bearer and the tenth network element. In the case where the first network element receives the first session establishment request from the first device or the further network element, that is, when the establishment of the first session of the first device is triggered by the first device or the further network element, after receiving the first session establishment request, the first network element may communicate with the first service about the first bearer which has already been established and the corresponding tenth network element, or the first network element may request, after receiving the first session establishment request, the first service to establish the first bearer and notify the first network element of the established first bearer and the tenth network element. Then the first network element acquires information about the first bearer and the tenth network element based on the first bearer response. For example, the C/M function acquires the ID of the first bearer and the ID of the tenth network element from CM service. It should be noted that throughout the text, although the number of the first bearer established for the first device is not limited in the embodiments of the present disclosure, there may be one or multiple bearers used for signaling exchange between the tenth network element and first device on the control and management plane.

The first network element and the second network element are in the same BAS domain. In actual applications, the first network element and the second network element can be in different BAS domains, in the following, the case where the first network element and the second network element are in the same BAS domain will be described in details, but it should be noted that the solution of the present disclosure is also applicable to the case where the first network element and the second network element are not in the same BAS domain.

As described above, the second network element is the serving C/M-TW-GW, which can be determined in the following manners.

In a possible implementation of the present disclosure, for the purpose of determining the second network element based on the first session establishment request, the first network element is configured to: acquire a current position of the first device and a movement prediction of the first device based on the first session establishment request; and determine the second network element based on the current position of the first device and the movement prediction of the first device.

In a possible implementation of the present disclosure, the first network element is configured to: acquire the current position of the first device and the movement prediction of the first device from a first service based on the first session establishment request. The first device can be a mobile device, and the first service (e.g., CM service) can acquire the current position and the movement prediction (such as a movement speed and a movement direction) of the first device, and can predict the position of the first device in the next seconds, minutes or hours, which is not limited here.

In a possible implementation of the present disclosure, when the establishment of the first session of the first device is triggered by the first service, the first session establishment request can further be indicative of the current position and the movement prediction of the first device, and the first network element can be configured to directly acquire the current position and the movement prediction of the first device from the first session establishment request, and determine the second network element based on the current position and the movement prediction of the first device, for example, the first network element selects a C/M-TW-GW closest to the first device as the second network element (i.e., serving C/M-TW-GW) in real-time in the BAS domain where the first network element is located.

In a possible implementation of the present disclosure, when the establishment of the first session of the first device is triggered by the first service and the first session establishment request does not carry information of the current position and the movement prediction of the first device, after receiving the first session establishment request, the first network element is configured to:
transmit a request to the first service and acquire the current position and the movement prediction of the first device based on a response which carries information of the current position and the movement prediction of the first device and is corresponding to the request, then determine the second network element based on the acquired current position and the movement prediction of the first device, for example, the first network element selects a C/M-TW-GW closest to the first device as the second network element (i.e., serving C/M-TW-GW) in real-time in the BAS domain where it is located. It should be noted that when the first session establishment request includes multiple different contents for indicating multiple different pieces of information, the multiple contents can be indicated separately in multiple request/response messages or together in one request/response message.

In a possible implementation of the present disclosure, when the establishment of the first session of the first device is triggered by the first device or the further network element, after receiving the first session establishment request from the first device or the further network element, the first network element is configured to transmit a request to the first service and acquire the current position and the movement prediction of the first device based on a response from the first service which carries information of the current position and the movement prediction of the first device and is corresponding to the request, then determine the second network element based on the acquired current position and the movement prediction of the first device, for example, the first network element selects a C/M-TW-GW closest to the first device as the second network element (i.e., serving C/M-TW-GW) in real-time in the BAS domain where the first network element is located. In a possible implementation, the first network element can be configured to transmit the request for acquiring the current position and the movement prediction and the first bearer request mentioned above to the first service together, or transmit them to the first service separately, which is not limited in the embodiments of the present disclosure.

In a possible implementation of the present disclosure, for the purpose of determining the second network element based on the first session establishment request, the first network element is configured to: determine the second network element based on the first session establishment request and capabilities of network elements managed by the first network element. In this case, the first session establishment request is regarded as a trigger for determining the second network element, so upon receiving the first session establishment request, the first network element may consider the capabilities of the managed network elements so as to determine a proper second network element. Information related to the capabilities of network elements managed by the first network element can be stored locally in the first network element or stored in other network elements connected to the first network element, so that the first network element can acquire the capabilities of network elements managed by the first network element. The network elements managed by the first network element can be C/M-TW-GWs managed by the C/M function. For example, the capabilities of network elements managed by the first network element can be traffic loads of the C/M-TW-GWs, the first network element may select a C/M-TW-GW with the smallest traffic load as the serving C/M-TW-GW, or the capabilities of network elements managed by the first network element can be distances between the C/M-TW-GWs and the first network element, the first network element may select a nearest C/M-TW-GW as the serving C/M-TW-GW, it should be understood that the selection criteria is simply for illustration purpose, and should not be construed as limitation to the embodiment of the present disclosure.

In a possible implementation of the present disclosure, for the purpose of determining the second network element based on the first session establishment request, the first network element is configured to: determine the second network element based on the current position and the movement prediction of the first device, and the capabilities of network elements managed by the first network element. In a possible implementation, the first network element first determines multiple candidate C/M-TW-GWs based on the acquired current position and the movement prediction of the first device, and then selects a C/M-TW-GW as the serving C/M-TW-GW from the multiple candidate C/M-TW-GWs based on the capabilities of the multiple candidate C/M-TW-GWs. In a possible implementation, the first network element first determines multiple candidate C/M-TW-GWs based on the capabilities of C/M-TW-GWs managed by the first network element, and then selects a C/M-TW-GW as the serving C/M-TW-GW from the multiple candidate C/M-TW-GWs based on the acquired current position and the movement prediction of the first device.

The configuration of the second network element to establish the first session between the first device and the second network element will be described in detail below.

In a possible implementation of the present disclosure, for the purpose of configuring the second network element, the first network element is configured to: determine a first bearer corresponding to the first session and the tenth network element based on the first session establishment request; assign the first session between the first device and the second network element; and transmit a third notification to the second network element, where the third notification is indicative of the first device, the first bearer, the first session and the tenth network element. Here the assignment of the first session can be, e.g., give an ID for uniquely identifying the first session.

In a possible implementation, when the establishment of the first session of the first device is triggered by the first service, as mentioned above, it is possible that the first session establishment request is indicative of the first bearer and the tenth network element, so the first network element can be configured to directly determine the first bearer corresponding to the first session and the third network element based on the first session establishment request. In a possible implementation, when the establishment of the first session of the first device is triggered by the first device or the further network element, as mentioned above, the first network element can be configured to acquire the first bearer response based on the first bearer request whose transmission is triggered by the first session establishment request, then determine the first bearer corresponding to the first session and the tenth network element based on the first bearer response. In a possible implementation, the third notification is used for notifying the second network element of the fact that the second network element is selected as the serving C/M-TW-GW, and can include the ID of the first device, an ID of the first bearer, an ID of the first session and an ID of the tenth network element.

In a possible implementation of the present disclosure, after the first network element transmits the third notification (which can be a possible implementation of a first session establishment notification) to the second network element, the second network element is configured to: receive the third notification from the first network element, and transmits a fourth notification to the tenth network element based on the first session establishment notification, where the fourth notification is indicative of the first device, the second network element, and a first mapping between the first bearer and the first session for the first device. The tenth network element then creates a mapping between the first device, the first bearer, the first session and the second network element based on the fourth notification received from the second network element.

In a possible implementation of the present disclosure, the second network element is configured to receive a third acknowledgement from the tenth network element, where the third acknowledgement is indicative of a reception of the fourth notification. The third acknowledgement can include any information such as the ID of the first device for responding to the fourth notification, as long as the third acknowledgement and the fourth notification are corresponding and the second network element gets acknowledge of the reception of the fourth notification.

In a possible implementation of the present disclosure, the second network element is configured to transmit a fifth notification to a second service, where the fifth notification is indicative of the first device, the second network element, a serving identification for the second network element and the first session. The second service can be a SPM (Service Provisioning Management) service, which provides a capability of control and management of 6G service access by customers and provisioning of requested services. The second network element transmits the fifth notification to the SPM service for security activation of the first session of the first device, and the SPM service can acquire the serving identification and the second network element based on the interface from which the fifth notification is received from the second network element, where the serving identification can be the ID of the BAS domain where the second network element is located.

In a possible implementation of the present disclosure, the second network element is configured to receive a fourth acknowledgement from the second service, where the fourth acknowledgement is indicative of a reception of the fifth notification. The fourth acknowledgement can include any information such as the ID of the first device and ID of the first session for responding to the fifth notification, as long as the fourth acknowledgement and the fifth notification are corresponding and the second network element gets acknowledge of the reception of the fifth notification.

In a possible implementation of the present disclosure, both of the fifth notification and the fourth acknowledgement include an identification of the first device and an identification of the first session.

In a possible implementation of the present disclosure, the first network element is configured to receive a first updating request from an eleventh network element, where the first updating request is indicative of the first device, the second network element, a serving identification for the second network element and the first session; and update a first local record based on the first updating request, where the first local record includes a mapping among the first device, the second network element, the serving identification for the second network element and the first session. The eleventh network element is a C/M-TW-GW in the BAS domain where the first network element is located, and is used for forwarding the first session establishment request from the first service, the first device or the further network element to the first network element. In a possible implementation, the eleventh network element can be the serving C/M-TW-GW (the second network element), when the first network element determines that the serving C/M-TW-GW is in its BAS domain and the eleventh network element which is connected to the first service is just the serving C/M-TW-GW, which is the case later shown in FIG. 10A and FIG. 10B. Besides, as mentioned above, the first network element also knows the tenth network element and the first bearer, therefore, the first local record can thus be the mapping among the first device, the second network element, the serving identification for the second network element, the first session, the first bearer corresponding to the first session and the tenth network element.

In this way, by virtue of the first session establishment request, the first network element can determine the first device, the first session for the first device, and the second network element (i.e., the serving C/M-TW-GW), and a BAS domain to which the second network element belongs; and configure the second network element based the above determined information; thus the first session for the first device can be established, thereby ensuring the information delivering on the control and management plane for the first device. Besides, the information related to the establishment of the first session can be updated to the second service (i.e., SPM service) for securing the first session and updated to the first service (i.e., CM service) for recording the information related to the establishment of the first session.

FIG. 10A illustrates an exemplary flowchart of an establishment of a first session for a first device in the case where the first network element and the second network element are in the same BAS domain, and the first session for the first device is triggered by the first service, and the method includes the following steps.

S1001A, the first network element receives a first session establishment request from a first service. Reference may be made to the above mentioned implementations.

S1002A, the first network element determines the second network element based on the first session establishment request. For the determination of the second network element, reference may be made to the above mentioned implementations.

S1003A, the first network element determines a first bearer corresponding to the first session and the tenth network element based on the first session establishment request; and assigns the first session between the first device and the second network element.

S1004A, the first network element transmits a third notification to the second network element, and the second network element receives the third notification.

S1005A, the second network element transmits a fourth notification to the tenth network element based on the third notification.

S1006A, the tenth network element creates a mapping between the first device, the first bearer, the first session and the second network element based on the fourth notification.

S1007A, the second network element receives a third acknowledgement from the tenth network element.

S1008A, the second network element transmits a fifth notification to a second service.

S1009A, the second service conducts security activation of the first session according to the received seventeen notification.

S1010A, the second network element receives a fourth acknowledgement from the second service, wherein the fourth acknowledgement is indicative of a reception of the fifth notification.

S1011A, the first network element receives a first updating request, when an eleventh network element used for forwarding the first session establishment request from the first service is the serving C/M-TW-GW (i.e., the second network element), the first network element receives the first updating request from the second network element, and when the eleventh network element is not the serving C/M-TW-GW, the first network element receives a first updating request from the second network element, the latter case is shown in the FIG. 10A.

S1012A, the first network element updates a first local record based on the first updating request, where the first local record includes a mapping among the first device, the second network element, a serving identification for the second network element and the first session.

S1013A, the first network element transmits a first session establishment response to the first service via the eleventh network element.

S1014A, the first service creates an entry including the first device, the serving identification for the second network element, the first session, the second network element, for example, an entry in a profile, which is not limited in the embodiment of the present disclosure.

For the possible implementations of the third notification, the fourth notification, the third acknowledgement, the fifth notification and the first session establishment response, reference may be made to the foregoing description.

In a possible implementation of the present disclosure, the establishment of a C/M session for the D-User (anchor) can be similar to that of the first device shown in FIG. 10A, except that it does not involve any process related to the setting up of the C/M RB (i.e., the first bearer mentioned above) and all the notifications/requests/responses/acknowledgements (if any) involved in the process of the establishment of the first session may be used in the same way for establishing the C/M session fort the D-user but be skipped of including indication of the first bearer.

FIG. 10B illustrates an exemplary flowchart of an establishment of a first session for a first device in the case where the first network element and the second network element are in the same BAS domain, and the session is triggered by the first device or a further network element, and the method includes the following steps.

S1001B, the first device or the further network element transmits a first session establishment request to the first network element, and the first network element receives the first session establishment request from the first device or the further network element.

S1002B, the first network element transmits a first bearer request for requesting a first bearer corresponding to the first session and a tenth network element to a first service, where the first bearer request is indicative of the first device.

S1003B, the first network element receives a first bearer response from the first service Reference may be made to the above mentioned implementations.

The steps of S1004B to S1014B are the same as those of S1002A to S1012A respectively, which will not be repeated here.

S1015B, the first network element transmits a second session establishment response to the first device or the further network element.

S1016B, the first network element transmits a notification which is indicative of the first device, the serving identification for the second network element, the first session, the second network element to the first service. In this case, although the establishment of the first session is triggered by the first device or further network element, the first network element will still notify the first service of the establishment of the first session.

S1017B, the first service creates an entry including the first device, the serving identification for the second network element, the first session, the second network element, for example, an entry in a profile, which is not limited in the embodiment of the present disclosure.

In a possible implementation of the present disclosure, the establishment of a C/M session (the abovementioned third session) for the D-user can be similar to that of the first device shown in FIG. 10B, except that it does not involve any process related to the setting up of the C/M RB (i.e., the first bearer mentioned above) and all the notifications/requests/responses/acknowledgements (if any) involved in the process of the establishment of the first session may be used in the same way for establishing the C/M session fort the D-user but be skipped of including indication of the first bearer.

In the following, a data session for a device is proposed to better manage the device/D-User (anchor) to access 6G system. The pre-conditions for establishing the data session is that BAS domain logical topology has been established; device's data RB and C/M RB have been set up.

In a possible implementation of the present disclosure, the first network element is configured to: receive a second session establishment request, where the second session establishment request is indicative of a first device for which a second session is to be established; and configure the third network element, based on the second session establishment request, to establish the second session between the first device and the third network element. The first device can be the wireless device mentioned above, the second session can be the data session for the first device mentioned above, and the third network element can be the serving Data-TW-GW of the first device. The second session establishment request can be seen as a trigger of the establishment of the first session, and upon receiving the second session establishment request, the first network element can start the configuration of the third network element. Depending on different content of the second session establishment request, the configuration procedure would be different.

In a possible implementation of the present disclosure, the second session establishment request includes an identification of the first device, for example, an ID of the first device, which is not limited in the embodiments of the present disclosure.

In a possible implementation of the present disclosure, the first network element is configured to receive the second session establishment request from a third service, the third service can be a MM (Mission Management) service, which provides a capability to program provisioning of XaaS services at Service Layer to provide mission service; and the first network element is further configured to transmit a third session establishment response to the third service in response to the second session establishment request, where the third session establishment response is indicative of the first device, for example, the third session establishment response can also include an ID of the first device, which is not limited in the embodiments of the present disclosure.

In a possible implementation of the present disclosure, the second session for the first device can be assigned by the third service (e.g., MM service) or assigned by the C/M function (the first network element or seventh network element mentioned above) in the same BAS domain as a serving Data-TW-GW, the serving Data-TW-GW is an endpoint on the network side for the second session of the first device. Here the assignment of the second session can be, e.g., give an ID for uniquely identifying the second session.

In the case where the first network element receives the second session establishment request from the third service, that is, when the establishment of the second session of the first device is triggered by the third service, the second session establishment request can be further indicative of a second bearer corresponding to the second session and a tenth network element, where a second mapping between the second bearer and the second session for the first device is maintained by the tenth network element, and the second bearer is established between the first device and the tenth network element. Besides, in a possible implementation, the third service can request the first service (e.g., CM service) to establish a connection between the first device and the tenth network element through the second bearer before triggering the establishment of the second session. The second bearer can be a data Radio Bearer (Data RB) of the first device, which is an over-the-air connection for carrying data plane traffic, the first service is the CM service, and tenth network element can be a RB handler. The third service knows the second bearer and the tenth network element before triggering the establishment of the second session, thus the second session establishment request can include an ID of the second bearer, an ID of the tenth network element. In another implementation, the first device can request the first service (e.g., CM service) to establish the connection between the first device and the tenth network element through the second bearer after receiving the second session establishment request, in this case, the second session establishment request is no longer indicative of the second bearer corresponding to the second session and the tenth network element, instead, the first service can inform the first network element of the second bearer corresponding to the second session and the tenth network element.

With respect to the indication of the second session, in the case where the first network element receives the second session establishment request from the third service, that is, when the establishment of the second session of the first device is triggered by the third service, the second session for the first device may have been assigned by the third service (e.g., MM service), so the second session establishment request can be indicative of the second session (e.g., include an ID of the second session).

It is also possible that the second session establishment request is not indicative of the second session, in a possible implementation, the first network element can check with the third service to get acknowledge of the second session, e.g., the first network element can request information of the second session (e.g., ID of the second session) from the third service after receiving the second session establishment request, for example, the C/M function requests an ID of the data session for the first device from the MM service for establishing the data session for the first device, In another possible implementation, the second session can be assigned by the C/M function in the same BAS domain as the serving Data-TW-GW. For example, the first network element can assign the second session itself if the serving Data-TW-GW is determined to be in the same BAS domain as the first network element, or it can wait for another network element (C/M function) in another BAS domain where the serving Data-TW-GW is located to assign the second session. Details about this implementation will be described later.

In a possible implementation of the present disclosure, the first network element is configured to receive the second session establishment request from the first device or a further network element; and the first network element is configured to transmit a fourth session establishment response to the first device or the further network element in response to the second session establishment request, where the fourth session establishment response is indicative of the first device, for example, the fourth session establishment response includes an ID of the first device, which is also not limited in the embodiments of the present disclosure.

In a possible implementation of the present disclosure, in the case where the first network element receives the second session establishment request from the first device or the further network element, that is, when the establishment of the second session of the first device is triggered by the first device or the further network element, the first network element is configured to: transmit a session request to a third service, where the session request is indicative of the first device; and receive a session response from the third service, where the session response is indicative of the second session. The first network element can request information of the second session from the third service after receiving the second session establishment request, for example, the C/M function requests an ID of the data session for the first device from the MM service for establishing the data session for the first device. In a possible implementation, the second session can be assigned by the C/M function in the same BAS domain as the serving Data-TW-GW. For example, the first network element can assign the second session itself if the serving Data-TW-GW is determined to be in the same BAS domain as the first network element, or it can wait for another network element (C/M function) in another BAS domain where the serving Data-TW-GW is located to assign the second session. Details about this implementation will be described later.

In a possible implementation of the present disclosure, the first network element is configured to: transmit a second bearer request for requesting a second bearer corresponding to the second session and a tenth network element to a first service, where the second bearer request is indicative of the first device; and receive a second bearer response from the first service, where the second bearer response is indicative of the second bearer corresponding to the second session and the tenth network element, where a second mapping between the second bearer and the second session for the first device is maintained by the tenth network element, and the second bearer is established between the first device and the tenth network element. In a possible implementation, the indication of the first device is sufficient to tell the first service that the first network element wants to know the second bearer and the tenth network element. In another possible implementation, the first bearer request can also carry other information indicating that the first network element wants to know the second bearer and the tenth network element. In the case where the first network element receives the second session establishment request from the first device or the further network element, that is, when the establishment of the second session of the first device is triggered by the first device or the further network element, after receiving the second session establishment request, the first network element transmits the second bearer request to the first service, one possible implementation is to use the second bearer request for requesting the establishment of a connection between the first device and the tenth network element through the second bearer, and use the second bearer response as a notification of the second bearer and the tenth network element, so that the first network element can get acknowledge of the second bearer and the tenth network element, for example, the C/M function acquires the ID of the second bearer and the ID of the tenth network element from CM service. The other possible implementation is to simply use the second bearer request for requesting the second bearer which has already been established and the corresponding tenth network element. It should be noted that throughout the text, although the number of the second bearer established for the first device is not limited in the embodiments of the present disclosure, there may be one or multiple bearers used for signaling exchange between the tenth network element and first device on the data plane.

The first network element and the third network element are in the same BAS domain. In actual applications, the first network element and the third network element can be in different BAS domains, in the following, the case where the first network element and the third network element are in the same BAS domain will be described in details, but it should be noted that the solution of the present disclosure is also applicable to the case where the first network element and the third network element are not in the same BAS domain.

As described above, the third network element is the serving Data-TW-GW, which can be determined in the following manners.

In a possible implementation of the present disclosure, for the purpose of determining the third network element based on the second session establishment request, the first network element is configured to: acquire a current position of the first device and a movement prediction of the first device based on the second session establishment request; and determine the third network element based on the current position of the first device and the movement prediction of the first device.

In a possible implementation of the present disclosure, the first network element is configured to: acquire the current position of the first device and the movement prediction of the first device from a first service based on the second session establishment request. The first device can be a mobile device, and the first service (e.g., CM service) can acquire the current position and the movement prediction (such as a movement speed and a movement direction) of the first device, and can predict the position of the first device in the next seconds, minutes or hours, which is not limited here.

In a possible implementation of the present disclosure, when the establishment of the second session of the first device is triggered by the third service, the third service can be configured to transmit a request for acquiring information of the current position and the movement prediction of the first device from the first service before triggering the establishment of the second session (before transmitting the second session establishment request), and this request and the second bearer request mentioned above can be transmitted together or separately to the first service, and the second session establishment request can include information of the current position and the movement prediction of the first device. The first network element can be configured to directly acquire the current position and the movement prediction of the first device from the second session establishment request, and determine the third network element based on the current position and the movement prediction of the first device. In a possible implementation, when the establishment of the second session of the first device is triggered by the third service, the first network element can be configured to transmit a request for acquiring information of the current position and the movement prediction of the first device from the third service after receiving the second session establishment request, and determine the third network element based on the current position and the movement prediction of the first device. For example, the first network element selects a Data-TW-GW closest to the first device as the third network element (i.e., serving Data-TW-GW) in real-time in the BAS domain where the first network element is located based on the current position and the movement prediction of the first device.

In a possible implementation of the present disclosure, when the establishment of the second session of the first device is triggered by the first device or the further network element, after receiving the second session establishment request from the first device or the further network element, the first network element is further configured to: transmit a request to the first service and acquire the current position and the movement prediction of the first device based on a response from the first service which carries information of the current position and the movement prediction of the first device and is corresponding to the request, determine the third network element based on the acquired current position and the movement prediction of the first device, for example, the first network element selects a Data-TW-GW closest to the first device as the third network element (i.e., serving Data-TW-GW) in real-time in the BAS domain where the first network element is located. In a possible implementation, the first network element can be configured to transmit the request for acquiring the current position and the movement prediction and the second bearer request mentioned above to the first service together, or transmit them to the first service separately, which is not limited in the embodiments of the present disclosure.

In a possible implementation of the present disclosure, for the purpose of determining the third network element based on the second session establishment request, the first network element is configured to: determine the third network element based on the second session establishment request and capabilities of network elements managed by the first network element. In this case, the second session establishment request is regarded as a trigger for determining the third network element, so upon receiving the second session establishment request, the first network element may consider the capabilities of the managed network elements so as to determine a proper third network element. Information related to the capabilities of network elements managed by the first network element can be stored locally in the first network element or stored in other network elements connected to the first network element, so that the first network element can acquire the capabilities of network elements managed by the first network element. The network elements managed by the first network element can be Data-TW-GWs managed by the C/M function. For example, the capabilities of network elements managed by the first network element can be traffic loads of the Data-TW-GWs, the first network element may select a Data-TW-GW with the smallest traffic load as the serving Data-TW-GW, or the capabilities of network elements managed by the first network element can be distances between the Data-TW-GWs and the first network element, the first network element may select a nearest Data-TW-GW as the serving Data-TW-GW, it should be understood that the selection criteria is simply for illustration purpose, and should not be construed as limitation to the embodiment of the present disclosure.

In a possible implementation of the present disclosure, for the purpose of determining the third network element based on the first session establishment request, the first network element is configured to: determine the third network element based on the current position and the movement prediction of the first device, and the capabilities of network elements managed by the first network element. In a possible implementation, the first network element first determines multiple candidate Data-TW-GWs based on the acquired current position and the movement prediction of the first device, and then selects a Data-TW-GW as the serving Data-TW-GW from the multiple candidate Data-TW-GWs based on the capabilities of the multiple candidate Data-TW-GWs. In a possible implementation, the first network element first determines multiple candidate Data-TW-GWs based on the capabilities of the Data-TW-GWs managed by the first network element, and then selects a Data-TW-GW as the serving Data-TW-GW from the multiple candidate Data-TW-GWs based on the acquired current position and the movement prediction of the first device.

It should be noted that under the premise that the serving C/M-TW-GW corresponding to the serving Data-TW-GW has been determined, the serving Data-TW-GW is determined by considering the information such as the current position and the movement prediction of the first device, and the capabilities of the Data-TW-GWs managed by the first network element.

The configuration of the third network element to establish the second session between the first device and the third network element will be described in detail below.

In a possible implementation of the present disclosure, for the purpose of configuring the third network element, the first network element is configured to: determine the second session, a second bearer corresponding to the second session and the tenth network element based on the second session establishment request; transmit a sixth notification to the third network element, where the sixth notification is indicative of the first device, the second bearer, the second session and the tenth network element; and transmit a seventh notification to a twelfth network element, where the seventh notification is indicative of the first device, the second bearer, the second session, the tenth network element and the third network element, where the twelfth network element interacts with the first device on a control and management plane. In a possible implementation, the third network element and the twelfth network element are both under control of the first network element and are both in the same BAS domain, which will be later shown in FIG. 11A and FIG. 11B.

With respect to the determination of the second session, the second bearer corresponding to the second session and the tenth network element, the first network element can be notified of the above information, or it can be simply notified of the second bearer corresponding to the second session and the tenth network element, but assign the second session per se.

In a possible implementation, when the establishment of the second session of the first device is triggered by the third service, the second session establishment request can be indicative of the second session or not. In the former case, the second session establishment request can be indicative of the second session, and as mentioned above, as a possible implementation, the third service can be configured to request the first service to acquire the second bearer corresponding to the second session and the tenth network element before triggering the establishment of the second session, the second session establishment request can thus also be indicative of the second bearer corresponding to the second session and the tenth network element, thus the first network element is configured to directly determine the second session, the second bearer corresponding to the second session and the tenth network element based on the second session establishment request. In a possible implementation, after the first network element receives the second session establishment request from the third service, the first network element is configured to: transmit a request to the third service to get acknowledge of the second session, transmit a request to the first service to get acknowledge of the second bearer corresponding to the second session and the tenth network element, then determine the second session, the second bearer corresponding to the second session and the tenth network element based on the responses corresponding to the above two requests.

In a possible implementation, when the establishment of the second session of the first device is triggered by the third service, but the second session establishment request is not indicative of the second session, or when the establishment of the second session of the first device is triggered by the first device or the further network element, after receiving the second session establishment request, the first network element is configured to transmit a request to the third service to get acknowledge of the second session; transmit the second bearer request to the first service to get acknowledge of the second bearer corresponding to the second session and the tenth network element, determine the second session, the second bearer corresponding to the second session and the tenth network element based on the responses corresponding to the above two requests.

In a possible implementation, when the establishment of the second session of the first device is triggered by the third service, but the second session establishment request is not indicative of the second session, or when the establishment of the second session of the first device is triggered by the first device or the further network element, the second session can be assigned by the C/M function in the same BAS domain as a serving Data-TW-GW, rather than being notified by the third service. For the second bearer and the tenth network element, the first network element can be configured to transmit the second bearer request to the first service to get acknowledge of the second bearer corresponding to the second session and the tenth network element, determine the second bearer corresponding to the second session and the tenth network element based on the second bearer response corresponding to the second bearer request.

The sixth notification is used for notifying the third network element of the fact that the third network element is selected as the serving C/M-TW-GW, and can include the ID of the first device, an ID of the second bearer, an ID of the second session and an ID of the tenth network element.

In a possible implementation of the present disclosure, after the first network element transmits the sixth notification (which can be a possible implementation of a second session establishment notification) to the third network element, the third network element is configured to receive the sixth notification, and the first network element is also configured to transmit a seventh notification to a twelfth network element, and the twelfth network element is configured to receive the seventh notification accordingly, where the twelfth network element interacts with the first device on a control and management plane in the BAS domain where the third network element is located, and the twelfth network element can be the serving C/M-TW-TW for the first device, the twelfth network element can be determined in the same way as the determination of the second network element described in the above implementations, or can be determined by other ways. Then the twelfth network element transmits an eighth notification to the tenth network element based on the sixth notification, the eighth notification is indicative of the first device, the sixth network element and a second mapping between the second bearer and the second session for the first device. The tenth network element creates a mapping between the first device, the second bearer, the second session and the third network element based on the eighth notification received from the twelfth network element. In a possible implementation, the tenth network element may also store the twelfth network element.

In a possible implementation of the present disclosure, the twelfth network element is configured to receive a fifth acknowledgement from the tenth network element, where the fifth acknowledgement is indicative of a reception of the eighth notification. The fifth acknowledgement can include any information such as the ID of the first device for responding to the eighth notification, as long as the fifth acknowledgement and the eighth notification are corresponding and the twelfth network element gets acknowledge of the reception of the eighth notification.

In a possible implementation of the present disclosure, the twelfth network element is configure to transmit a ninth notification to a second service, where the ninth notification is indicative of the first device, the second session, the third network element and a serving identification for the third network element. The second service can be a SPM (Service Provisioning Management) service, which provides a capability of control and management of 6G service access by customers and provisioning of requested services. The twelfth network element is configured to transmit the ninth notification to the SPM service for security activation of the second session of the first device, and the SPM service can acquire the serving identification and the twelfth network element based on the interface for which the ninth notification is received from the twelfth network element, where the serving identification can be the ID of the BAS domain where the third network element and the twelfth network element are located.

In a possible implementation of the present disclosure, the twelfth network element is configure to receive a sixth acknowledgement from the second service, where the sixth acknowledgement is indicative of a reception of the ninth notification. The sixth acknowledgement can include any information such as the ID of the first device and ID of the second session for responding to the ninth notification, as long as the sixth acknowledgement and the ninth notification are corresponding and the twelfth network element gets acknowledge of the reception of the ninth notification.

In a possible implementation of the present disclosure, both of the ninth notification and the sixth acknowledgement include an identification of the first device and an identification of the second session.

In a possible implementation of the present disclosure, the first network element is configured to receive a second updating request from an eleventh network element, where the second updating request is indicative of the first device, the third network element, a serving identification for the third network element and the second session; and update a second local record based on the second updating request, where the second local record includes a mapping among the first device, the third network element, the serving identification for the third network element and the second session. In a possible implementation, the first network element is configured to receive the second updating request forwarded by the eleventh network element from the twelfth network element, and the eleventh network element is a C/M-TW-GW in the BAS domain where the first network element is located, and is used for forwarding the second session establishment request from the third service, the first device or the further network element to the first network element. In a possible implementation, the eleventh network element can be the serving C/M-TW-GW (the twelfth network element), when the first network element determines that the serving C/M-TW-GW is in its BAS domain and the eleventh network element which is connected to the first service is just the serving C/M-TW-GW, which is the case later shown in FIG. 11A and FIG. 11B. Besides, as mentioned above, the first network element also knows the tenth network element and the second bearer, therefore, the second local record can thus be the mapping among the first device, the third network element, the serving identification for the third network element, the second session, the second bearer corresponding to the second session and the tenth network element.

In this way, by virtue of the second session establishment request, the first network element can determine the first device, the second session for the first device, and the third network element (i.e., the serving Data-TW-GW); and configure the third network element based the above determined information; thus the second session for the first device can be established, thereby ensuring the information delivering on the data plane for the first device. Besides, the information related to the establishment of the second session can be updated to the second service (i.e., SPM service) for securing the second session and updated to the first service (i.e., CM service) for recording the information related to the establishment of the second session.

FIG. 11A illustrates an exemplary flowchart of an establishment of a second session for a first device in the case where the first network element and the third network element are in the same BAS domain, the second session for the first device is triggered by the third service, the second session is assigned by the C/M function in the same BAS domain as a serving Data-TW-GW rather than being notified by the third service, and the third service has already acquired the second bearer corresponding to the second session and the tenth network element from the third service before triggering the establishment of the second session, and the method includes the following steps.

S1101A, the first network element receives a second session establishment request from a third service. Reference may be made to the above mentioned implementations.

S1102A, the first network element determines a third network element based on the second session establishment request. For the determination of the third network element, reference may be made to the above mentioned implementations.

S1103A, the first network element determines the second bearer corresponding to the second session and the tenth network element based on the second session establishment request, and assigns the second session between the first device and the third network element.

S1104A, the first network element transmits a sixth notification to the third network element.

S1105A, the first network element transmits a seventh notification to the twelfth network element, and the twelfth network element receives the seventh notification.

S1106A, the twelfth network element transmits an eighth notification to the tenth network element based on the seventh notification.

S1107A, the tenth network element creates a mapping between the first device, the second bearer, the second session and the third network element based on the eighth notification. In a possible implementation, the tenth network element can also record the twelfth network element in said mapping.

S1108A, the twelfth network element receives a fifth acknowledgement from the tenth network element.

S1109A, the twelfth network element transmits a ninth notification to a second service.

S1110A, the second service conducts security activation of the second session according to the received ninth notification.

S1111A, the twelfth network element receives a sixth acknowledgement from the second service.

S1112A, the first network element receives a second updating request from the twelfth network element.

S1113A, the first network element updates a second local record based on the second updating request, where the second local record includes a mapping among the first device, the third network element, a serving identification for the third network element and the second session. In a possible implementation, the second local record may also record the twelfth network element.

S1114A, the first network element transmits a third session establishment response to the third service via the twelfth network element for responding to the second session establishment request.

S1115A, the first network element transmits a message to the first service via the twelfth network element, here the message is indicative of the first device, the third network element, the serving identification for the third network element, the twelfth network element and the second session.

S1116A, the first service creates an entry including the first device, the serving identification for the third network element, the second session, the third network element and the twelfth network element, for example, an entry in a profile, which is not limited in the embodiment of the present disclosure.

For the possible implementations of the seventh notification, the eighth notification, the fifth acknowledgement, the ninth notification, the sixth acknowledgement and the third session establishment response, reference may be made to the foregoing description.

In a possible implementation of the present disclosure, the establishment of a data session (the abovementioned fourth session) for the D-user can be similar to that of the first device shown in FIG. 11A, except that it does not involve any process related to the setting up of the data RB (i.e., the second bearer mentioned above) and all the notifications/requests/responses/acknowledgements (if any) involved in the process of the establishment of the second session may be used in the same way for establishing the data session fort the D-user but be skipped of including indication of the second bearer.

FIG. 11B illustrates an exemplary flowchart of an establishment of a second session for a first device in the case where the first network element and the third network element are in the same BAS domain, the session is triggered by the first device or a further network element, and the second session is assigned by the C/M function in the same BAS domain as a serving Data-TW-GW rather than being notified by the third service, and the method includes the following steps.

S1101B, the first device or the further network element transmits a second session establishment request to the first network element, and the first network element receives the second session establishment request from the first device or the further network element.

S1102B, the first network element transmits a second bearer request for requesting a second bearer corresponding to the first session and a tenth network element to a first service. Reference may be made to the above mentioned implementations.

S1103B, the first network element receives a second bearer response from the first service. Reference may be made to the above mentioned implementations.

The steps of S1104B to S1115B are the same as those of S1102A to S1113A respectively, which will not be repeated here.

S1116B, the first network element transmits a fourth session establishment response to the first device or the further network via the twelfth network element for responding to the second session establishment request, where the fourth session establishment response is indicative of the first device, and the first device or the further network receives the fourth session establishment response from the first network element.

S1117B, the first network element transmits a message to the first service via the twelfth network element, here the message is indicative of the first device, the third network element, the serving identification for the third network element, the second session and the twelfth network element.

S1118B, the first service creates an entry including the first device, the serving identification for the third network element, the second session, the third network element and the twelfth network element, for example, an entry in a profile, which is not limited in the embodiment of the present disclosure.

It should be noted that in this example, the twelfth network element is shown as an intermediate network element for enabling the communication between the first network element and the first service or the third service, it is also possible that another network element (C/M-TW-GW) different from the twelfth network element serves as such intermediate network element, which is not limited in the embodiments of the present disclosure.

In a possible implementation of the present disclosure, the establishment of a data session (the abovementioned fourth session) for the digital function associated with the first device can be similar to that of the first device shown in FIG. 11B, except that it does not involve any process related to the setting up of the data RB (i.e., the second bearer mentioned above) and all the notifications/requests/responses/acknowledgements (if any) involved in the process of the establishment of the second session may be used in the same way for establishing the fourth session but be skipped of including indication of the second bearer.

Note that the network elements mentioned in the present disclosure are all logical network elements, which can be implemented as individual devices, or can be implemented as chips or modules that could be integrated into a certain device.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

What is claimed is:

1. A communication system, comprising a first network element, at least one second network element, and at least one third network element, wherein:
the first network element is communicatively connected to the at least one second network element and the at least one third network element, and configured to control operations of the at least one second network element and the at least one third network element;
a second network element of the at least one second network element is communicatively connected to a fourth network element and configured to interact with the fourth network element on a control and management plane; and
a third network element of the at least one third network element is communicatively connected to a fifth network element and configured to interact with the fifth network element on a data plane.

2. The system according to claim 1, wherein the first network element is further configured to:
obtain a first profile of the fourth network element; and
configure the second network element based on the first profile, wherein:
the first profile comprises at least one of a reachable address of the fourth network element configured to establish a connection between the fourth network element and the second network element or an authorization profile of the fourth network element, and the authorization profile of the fourth network element is configured to determine a consumer to which the fourth network element is capable of providing a first basic service.

3. The system according to claim 2, wherein the first network element is further configured to transmit information in the first profile to the second network element, and wherein the second network element is configured to receive the information in the first profile from the first network element.

4. The system according to claim 1, wherein the first network element is configured to:
obtain a second profile; and
configure the third network element based on the second profile, wherein the second profile comprises at least one of a mission profile of the third network element or a reachable address of the fifth network element, the mission profile indicates an execution of an action in a mission by the third network element, and the reachable address of the fifth network element configured to establish a connection between the third network element and the fifth network element.

5. The system according to claim 4, wherein the second profile comprises the reachable address of the fifth network element, and the first network element is further configured to receive the second profile from the fifth network element.

6. The system according to claim 5, wherein:
the first network element is further configured to transmit information in the second profile to the third network element; and
the third network element is further configured to receive the information in the second profile from the first network element.

7. The system according to claim 1, wherein:
the second network element is further configured to transmit a first load report to the first network element, wherein the first load report is indicative of load traffic handled by the second network element; and
the first network element is further configured to receive the first load report from the second network element.

8. The system according to claim 7, wherein:
the at least one second network element comprises two or more second network elements; and
the first network element is further configured to select one of the two or more second network elements based on first load reports from the two or more second network elements.

9. The system according to claim 1, wherein:
the third network element is further configured to transmit a second load report to the first network element, wherein the second load report is indicative of load traffic handled by the third network element; and
the first network element is further configured to receive the second load report from the third network element.

10. The system according to claim 9, wherein:
the at least one third network element comprises two or more third network elements; and
the first network element is further configured to select one of the two or more third network elements based on second load reports from the two or more third network elements.

11. The system according to claim 1, wherein:
the first network element is further configured to: instruct the second network element to log interactions between the second network element and the fourth network element; and
the second network element is further configured to log the interactions between the second network element and the fourth network element, and report a log result to the first network element.

12. The system according to claim 1, wherein:
the first network element is further configured to: instruct the third network element to log interactions between the third network element and the fifth network element; and
the third network element is further configured to log the interactions between the third network element and the fifth network element, and report a log result to the first network element.

13. The system according to claim 1, wherein the second network element is further configured to:
receive a first request message from the fourth network element, wherein the first request message is indicative of a work requested by the fourth network element; and
determine, based on the first request message, a procedure for implementing the work requested by the fourth network element.

14. The system according to claim 1, wherein the third network element is further configured to perform at least one of:
processing a data format of a data packet when transferring the data packet; or
at least one of decryption or encryption operation when transferring a data packet.

15. The system according to claim 1, wherein the first network element is communicatively connected to a seventh network element and further configured to coordinate processes and data packets exchange on the data plane with the seventh network element.

16. The system according to claim 15, wherein the first network element is further configured to:
obtain a third profile, wherein the third profile comprises reachable addresses of an eighth network element and a ninth network element under control of the seventh network element, the reachable address of the eighth network element is configured to establish a connection between the second network element and the eighth network element, and the reachable address of the ninth network element is configured to establish a connection between the third network element and the ninth network element;
configure the second network element and the eighth network element to establish the connection between the second network element and the eighth network element; and
configure the third network element and the ninth network element to establish the connection between the third network element and the ninth network element.

17. The system according to claim 1, wherein the first network element is further configured to:
receive a first session establishment request, wherein the first session establishment request is indicative of a first device for which a first session is to be established; and
configure the second network element based on the first session establishment request to establish the first session between the first device and the second network element.

18. The system according to claim 1, wherein the first network element is further configured to:
receive a second session establishment request, wherein the second session establishment request is indicative of a first device for which a second session is to be established; and
configure the third network element based on the second session establishment request to establish the second session between the first device and the third network element.

19. The system according to claim 1, wherein the at least one second network element comprises two or more second network elements, and at least two of the two or more second network elements are communicatively connected.

20. The system according to claim 1, wherein the at least one third network element comprises two or more third network elements, and at least two of the two or more third network elements are communicatively connected.
